(19) United States
(12) Patent Application Publication
(10) Pub. No.: US 2026/0141888 A1
(43) Pub. Date: May 21, 2026

(54) Systems And Methods For Improving Energy Device Performance

(71) Applicant: Sonocharge Energy, Inc, Mountain View, CA (US)

(72) Inventors: An Huang, San Diego, CA (US); Haodong Liu, San Diego, CA (US)

(21) Appl. No.: 19/369,525

(22) Filed: Oct. 27, 2025

Related U.S. Application Data
(63) Continuation of application No. PCT/US24/26559, filed on Apr. 26, 2024.
(60) Provisional application No. 63/499,188, filed on Apr. 28, 2023.

(51) Int. Cl. G10K 15/04

(52) U.S. Cl. CPC G10K 15/04

(57) ABSTRACT

Provided herein are devices, systems, and methods for improving performance and lifetime of energy devices. In some embodiments, the present disclosure provides an acoustic module for improving energy device performance, the acoustic module comprising: at least one acoustic device configured to be operably coupled to an energy device, wherein the at least one acoustic device comprises (1) an acoustic wave generator configured to generate acoustic waves and (2) a housing enclosing the acoustic wave generator, wherein the housing is configured to be attached to an external surface of the energy device in a configuration that permits the acoustic waves to be streamed into the energy device; and at least one controller configured to control the at least one acoustic device to stream the acoustic waves into the energy device.

### CROSS-REFERENCE TO RELATED APPLICATIONS

This application is a continuation of PCT Application No. PCT/US2024/026559 filed 2024 Apr. 26, which claims the benefit under 35 U.S.C. § 119(e) of U.S. Provisional Patent Application No. 63/499,188, filed 2023 Apr. 28, both of which are incorporated herein by reference in their entirety for all purposes.

### BACKGROUND

The surge in global demand for energy over the last decades has spurred a concurrent demand for high-capacity and long-lasting energy devices to meet present and future global energy demand.

Lithium ion batteries (LIBs) have a cathode and an anode, which are both separated by a separator. During a charge cycle, lithium ions (Li⁺) migrate from the cathode to the anode through a gap having electrolytes. During a discharge cycle, lithium ions migrate from the anode to the cathode, as current is provided from the batteries to a device or apparatus, such as an electric vehicle. In some instances, the charge carriers can be inhomogeneously distributed over a surface of the electrode, causing the formation of metal protrusions comprising the charge carriers. In some instances, the protrusions may bridge a connection between the electrodes, resulting in shorting of the battery, thus shortening the lifecycle of the battery and also causing safety issues. To this end, batteries with rapid charging, high energy, good safety, and longer lifecycles are highly desirable.

### SUMMARY

An acoustic module for improving performance and lifetime of an energy device (e.g., a battery) is disclosed. The acoustic module can include an acoustic device. The acoustic device can include an acoustic wave generator capable of generating acoustic waves that facilitate metal ion transportation, mitigate or modulate metal ion deposition and/or inhomogeneous distribution that deleteriously impacts battery performance. The acoustic module or acoustic device can be internal or external to the energy device, which can be a cell, a battery, a battery module, or a battery pack. The acoustic module or acoustic device can be integrated into an energy system in a cost-effective and flexible manner for modulating/reducing metal growths and protrusions that form within a battery under fast charging, and/or low temperature charging, and/or over many charge and discharge cycles. Additionally, the acoustic module or acoustic device may be integrated into or with one or more energy devices, which can be scaled into energy systems.

The acoustic module may include an acoustic device operably coupled to an energy device. The acoustic device can include an acoustic wave generator configured to generate acoustic waves. The acoustic device can include a housing that encloses the acoustic wave generator. The housing can be attached to an external surface of the energy device that allows for acoustic waves to be streamed into the energy device. The acoustic module can include a controller that is configured to control the acoustic wave generator in the acoustic device. The generated acoustic waves can modulate or prevent formation of metal-containing protrusions (e.g., Li dendrites) in energy devices, such as electrochemical cells (e.g., battery cells, electrolysis cells, etc.). The acoustic device can be modularly assembled or mounted adjacent to an energy device, thereby providing a source of acoustic waves without integrating the acoustic device within the energy device. Additionally, the housing of the acoustic device can be customized to allow for greater flexibility in terms of controlling a relative direction of the acoustic waves. A plurality of acoustic modules can be used and geometrically designed to be used with batteries, battery modules, or battery packs to improve energy device performance (e.g., charge time, lifetime, number of cycles of charge/discharge prior to expending an energy device, e.g., an LIB).

In an aspect, the present disclosure provides an acoustic module for improving energy device performance, the acoustic module comprising: at least one acoustic device configured to be operably coupled to an energy device, wherein the at least one acoustic device comprises (1) an acoustic wave generator configured to generate acoustic waves and (2) a housing enclosing the acoustic wave generator, wherein the housing is configured to be attached to an external surface of the energy device in a configuration that permits the acoustic waves to be streamed into the energy device; and at least one controller configured to control the at least one acoustic device to stream the acoustic waves into the energy device.

In some embodiments, the at least one acoustic device is provided in a quantity based at least on a cell geometry and/or pack design of the energy device, for optimizing improvements in the energy device performance.

The acoustic device can be positioned relative to an electrode gap or direction of cation flow within the energy device. For example, the acoustic device can be placed with respect to a central axis or plane of the energy device. The axes or planes can correspond to a direction of cation flow. The acoustic waves can be streamed in a direction substantially parallel, antiparallel, orthogonal, or a combination thereof, to the electrode gap or the direction of cation flow (e.g., Li⁺). A combination of acoustic devices can be used to generate acoustic waves in a plurality of directions (e.g., parallel and/or orthogonal to the direction of Li⁺ migration). An acoustic device can provide an acoustic streaming direction that is independent of the position of battery tabs of the energy device. Alternatively, an acoustic device can provide an acoustic streaming direction that depends on the position of the battery tabs of the energy device.

In some embodiments, the configuration permits the acoustic waves to be streamed in a direction that is substantially orthogonal to an electrode gap of the energy device. In some embodiments, the configuration permits the acoustic waves to be streamed in a direction that is non-orthogonal to an electrode gap of the energy device. In some embodiments, the configuration permits the acoustic waves to be streamed in a direction that is substantially parallel to an electrode gap of the energy device. In some embodiments, configuration permits the acoustic waves to be streamed in a direction that is non-parallel to an electrode gap of the energy device. In some embodiments, the configuration provides an acoustic streaming direction that is independent of a position of one or more tabs of the energy device. In some embodiments, the configuration provides an acoustic streaming direction that is dependent on a position of one or more tabs of the energy device. In some embodiments, the at least one acoustic device has a same dimension as the energy device along at least one axis. In some embodiments, the at least one acoustic device has a different dimension from the energy device along at least one axis. In some embodiments, the at least one acoustic device has a same width as the energy device. In some embodiments, the at least one acoustic device has a same length as the energy device. In some embodiments, the at least one acoustic device has a same height as the energy device. In some embodiments, the at least one acoustic device has a smaller width than the energy device. In some embodiments, a width of the at least one acoustic device ranges from about 0.0001% to about 100% of a width of the energy device. In some embodiments, a height of the at least one acoustic device ranges from about 10 μm to about 5 mm. In some embodiments, a length or a width of the at least one acoustic device ranges from 10 μm to about 10 inches. In some embodiments, the housing is configured to be attached to the external surface of the energy device such that the housing covers an entire plane extending across the external surface. In some embodiments, the housing is configured to be attached to a portion of the external surface of the energy device. In some embodiments, the portion is located near or at an edge of the external surface of the energy device. In some embodiments, the portion is located near or at a center of the external surface of the energy device. In some embodiments, the portion is offset from a center of the external surface of the energy device.

Optionally, a coupling agent can be used to secure the acoustic device to the energy device. In some instances, the coupling agent establishes a connection between the housing of the acoustic device and an external surface of the energy device. The coupling agent can be a chemical agent or a physical mechanism. The coupling agent can partially or entirely fill a gap between the energy device and the acoustic device.

In some instances, the coupling agent can be aligned with the acoustic device. In other instances, the coupling agent need not be aligned to the acoustic device. The acoustic device can be mounted over an external surface of the energy device. The external surface of the energy device can be planar or non-planar. When the energy device is a cylindrical device, the acoustic device can be mounted over the rounded surface. The external surface can be the largest surface of the energy device. In some cases, the external surface can be the smallest surface of the energy device.

In some embodiments, the coupling agent comprises a paste, a mechanical fixture, or a coupling fluid. In some embodiments, the coupling agent is configured to completely fill a gap between a surface of the at least one acoustic device and the external surface of the energy device. In some embodiments, the coupling agent is configured to partially fill a gap between a surface of the at least one acoustic device and the external surface of the energy device. In some embodiments, about 0.1% to about 100% of a width of the gap is filled by the coupling agent. In some embodiments, the coupling agent is configured to extend beyond a gap between a surface of the at least one acoustic device and the external surface of the energy device. In some embodiments, the coupling agent is configured to completely cover an entire plane extending across the external surface of the energy device.

In some embodiments, the external surface comprises a planar surface of the energy device. In some embodiments, the planar surface corresponds to a largest planar surface of the energy device. In some embodiments, the external surface comprises a non-planar surface of the energy device. In some embodiments, the external surface comprises a cylindrical surface of the energy device. In some embodiments, the housing is configured to conform to the external surface of the energy device. In some embodiments, the at least one acoustic device comprises a plurality of acoustic devices having housings that are configured to be attached to the external surface of the energy device. In some embodiments, the plurality of acoustic devices is configured to be attached to the external surface such that the plurality of acoustic devices lies on a same plane extending across the external surface. In some embodiments, the external surface of the energy device comprises at least two external surfaces that lie on different planes, and wherein the plurality of acoustic devices is configured to be attached to the at least two external surfaces. In some embodiments, the at least two external surfaces are orthogonal to one another. In some embodiments, the at least two external surfaces are parallel to one another. In some embodiments, the at least two external surfaces are opposite to one another. In some embodiments, the at least two external surfaces are adjacent to one another. In some embodiments, the different planes are located on at least two different axes. In some embodiments, the plurality of acoustic devices comprises two to about five hundred acoustic devices. In some embodiments, the plurality of acoustic devices comprises more than five hundred acoustic devices.

In some embodiments, the acoustic wave generator is configured to generate the acoustic waves to trigger microscale or nanoscale acoustofluidics in a presence of a fluid located within the energy device. In some embodiments, the acoustic wave generator comprises a piezoelectric material. In some embodiments, the acoustic waves comprise surface acoustic waves (SAW). In some embodiments, the SAW comprises one or more wave types. In some embodiments, the one or more wave types comprise leaky SAW, love wave, Bleustein Gulyaev wave, surface skimming bulk wave, surface transverse waves, or any combination thereof. In some embodiments, the acoustic waves comprise a bulk wave selected from the group consisting of thickness mode wave, thickness shear mode wave, longitudinal bulk wave, and any combination thereof. In some embodiments, the at least one controller is configured to control the acoustic wave generator to generate the acoustic waves at a frequency ranging from 10 Hz to 500 MHz. In some embodiments, the at least one controller is configured to control the acoustic wave generator to generate the acoustic waves with a power ranging from 0.1 mW to 500 MW. In some embodiments, the at least one controller is configured to control the acoustic wave generator to generate the acoustic waves having one or more waveforms selected from the group consisting of continuous sine wave, square wave, and triangular wave. In some embodiments, the at least one controller is configured to control the acoustic wave generator to generate the acoustic waves with on/off pulsing ranging from 0% to 100%. In some embodiments, the at least one controller is configured to control the acoustic wave generator to generate the acoustic waves with a timescale period ranging from about 1 microsecond to about 1 millisecond. In some embodiments, the at least one acoustic device is configured to suppress Li ion concentration gradient (i) in a bulk electrolyte and/or (ii) in pores of at least one electrode of the energy device. In some embodiments, the at least one acoustic device is configured to suppress counter anion concentration gradient (i) in a bulk electrolyte and/or (ii) in pores of at least one electrode of the energy device. In some embodiments, the at least one acoustic device is configured to facilitate (i) Li ion diffusivity in a bulk electrolyte, (ii) at an electrolyte and electrode interface, and/or (iii) in at least one electrode of the energy device. In some embodiments, the at least one acoustic device is configured to suppress/eliminate dendritic Li formation and promote dense large Li particle formation in the energy device. In some embodiments, the at least one acoustic device is configured to suppress/eliminate dendritic Li formation and promote Li transport into an anode material of the energy device. In some embodiments, the at least one acoustic device is configured to mitigate volume swelling/expansion of at least one cell in the energy device as the energy device undergoes multiple charge cycles. In some embodiments, the at least one controller is provided separately from the at least one acoustic device. In some embodiments, the at least one controller is integrated onboard the at least one acoustic device. In some embodiments, the at least one controller is in wireless communication with the at least one acoustic device. In some embodiments, the at least one controller is electrically coupled to the at least one acoustic device.

In an aspect, the present disclosure provides an energy system comprising an acoustic module and an energy device disclosed herein. In some embodiments, the energy device comprises one or more cells. In some embodiments, the one or more cells comprise one or more battery cells. In some embodiments, the one or more cells comprise one or more fuel cells. In some embodiments, the one or more cells comprise at least one battery cell and at least one fuel cell. In some embodiments, the energy device comprises one or more battery modules. In some embodiments, the energy device comprises one or more battery packs. In some embodiments, the energy device has a regular shape. In some embodiments, the energy device has an irregular shape or a customed shape. In some embodiments, the energy device comprises one or more pouch cells, prismatic cells, or cylindrical cells. The energy device can comprise at least two electrodes. The two electrodes can be a cathode and an anode. The cathode can comprise Li. In some cases, the cathode can comprise a material selected from the group of LifePO₄; LiFeₓMn_{y}PO₄, wherein x+y=1; LiMn₂O₄; LiNi_{0.5}Mn_{1.5}O₄; LiNiₓCo_{y}Mn₂O₂, wherein x+y+z=1; LiCoO₂; LiNiₓCo_{y}Al₂O₂, wherein x+y+z=1; and αLiNiₓCo_{y}Mn₂O₂·(1−α)Li₂MnO₃, wherein α=0-1 and x+y+z=1. In some instances, the cathode is Li-free. The cathode can comprise a material selected from the group of oxides, fluorides, oxyfluorides, sulfur-based materials, and gases. In some embodiments, the energy device comprises at least one cathode that is Lithium free. In some embodiments, the energy device comprises at least one anode. The anode can be a Li-containing material. In some embodiments, the anode can comprise Li metal foil, Li metal on Cu foil, Li metal on carbon substrate, Li metal on porous metal substrate, or Li metal on porous carbon substrate. In some embodiments, the anode comprises graphite, graphene, Al, Cu, Si, Sn, SiOₓ, SnOₓ, P, lithium titanium oxide (LTO), hard carbon, or soft carbon, or a combination thereof. The energy device can also have an electrolyte. In some embodiments, the energy device comprises an electrolyte comprising a nonaqueous electrolyte, an aqueous electrolyte (e.g., a water in salt electrolyte), a semi-solid electrolyte, a liquified gas electrolyte, or a polymer gel electrolyte. In some embodiments, the energy devices herein can be any energy generating or energy storing device. The energy device can be a regularly shaped or irregularly shaped battery.

The acoustic device can be assembled, mounted, or integrated adjacent to the energy device in a number of configurations. The acoustic device can be mounted relative to a center (e.g., centered or offset from the center) of the energy device. In some instances, the acoustic device can be mounted adjacent to an edge of the energy device, such that the acoustic device is offset from the center of the energy device.

Each of the energy device, acoustic device, and coupling agent (when present) can comprise a plurality of dimensions, such as a length, a width (e.g., a thickness), and a height. Each of the dimensions of the energy device, acoustic device, and coupling agent (when present) can be the same. In some cases, two of the dimensions of the energy device, acoustic device, and coupling agent can be different. In some cases, each of the dimensions of the energy device, acoustic device, and coupling agent can be different.

Multiple acoustic devices can be integrated into an acoustic module. Multiple acoustic devices can be coupled to (e.g., mounted) an energy device. Each of the multiple acoustic devices can be mounted onto an external surface of the energy device. In some cases, each of the multiple acoustic devices may be mounted onto one external surface of the energy device. In some instances, the multiple acoustic devices can be mounted onto the external surface such that the multiple acoustic devices interface with at least two external surfaces of the energy device. The at least two external surfaces can be parallel to each other. The at least two external surfaces can be opposite to one another. The at least two external surfaces can be orthogonal to one another. Alternatively, the at least two external surfaces can be orthogonal to one another.

Energy systems, such as batteries, battery modules, battery packs, fuel cell apparatuses, or electrochemical cell apparatuses, can utilize the acoustic devices herein. To accommodate the larger energy systems, individual cells (e.g., battery cells, fuel cells, electrochemical cells) can be individually integrated with an acoustic device (or multiple acoustic devices), then assembled to form a larger module or pack that can be integrated alongside (e.g., externally) to the energy system. The module or pack can be in electronic communication with the energy system. In some instances, a plurality of acoustic devices can be assembled within the module or pack, such that the module or pack can be integrated alongside (e.g., externally) to the energy system. In some instances, two to five hundred acoustic devices may be assembled together. In some cases, over five hundred acoustic devices can be used with the energy system. The energy systems, in turn, can be integrated into one or more products (e.g., consumer electronics such as mobile devices and laptops, electric vehicles, electric vertical take-off and landing aircrafts (eVTOLs), drones, manned aircraft, unmanned aircraft, delivery robots, e-bicycles, e-scooters, robotics or robots, grid energy storage, and the like).

In an aspect, provided herein are methods for assembling an energy system using the acoustic devices herein. A method can comprise providing at least one acoustic device. The at least one acoustic device can comprise an acoustic wave generator and a housing enclosing the acoustic wave generator. The method can comprise operably coupling the at least one acoustic device to an energy device, thus forming or constructing the energy system. The housing of the at least one acoustic device can be attached to the external surface of the energy device. In some instances, the method can further comprise incorporating the energy system as described above into one or more products. In some instances, the method can comprise using at least one controller to control the acoustic wave generator. The controller enables control over the features of the acoustic waves to improve energy device performance for the one or more products.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which the principles of the invention are utilized, and the accompanying drawings (also “Figure” and “FIG.” herein), of which:

FIG. 1A illustrates schematics of a cell comprising a cathode and an anode in an energy device (FIG. 1A(i)) in the absence (FIG. 1A(ii) and presence (FIG. 1A(iii)) of an acoustic module as described herein;

FIG. 1B shows an acoustic device operably coupled to an energy device, in accordance with some embodiments;

FIG. 1C shows an acoustic module operably coupled to an energy device, in accordance with some embodiments;

FIG. 1D shows an acoustic device, in accordance with some embodiments;

FIG. 2A shows a front view of an energy device, a coupling agent, and an acoustic device, in accordance with some embodiments;

FIG. 2B illustrates a perspective view of the energy device of FIG. 2A, in accordance with some embodiments;

FIG. 2C illustrates a rear view of the energy device 2A, in accordance with some embodiments;

FIGS. 3A-3C illustrate an energy device coupled with an acoustic device, where the acoustic device generates acoustic waves in a direction parallel to a cation flow and can be positioned in various ways relative to the energy device, in accordance with some embodiments;

FIGS. 4A-4C illustrate energy devices, acoustic devices, and coupling agents, wherein the coupling agents and the acoustic devices have a dimension that is the same, in accordance with some embodiments;

FIGS. 5A-5C illustrate energy devices, acoustic devices, and coupling agents, wherein the coupling agents and the acoustic devices have a dimension that is the same, and the acoustic devices and coupling agents are positioned in various ways relative to the energy device, in accordance with some embodiments;

FIGS. 6A-6C illustrate energy devices, acoustic devices, and coupling agents, wherein the energy devices, coupling agents, and acoustic devices have different dimensions, and the acoustic devices and coupling agents are positioned in various ways relative to the energy device, in accordance with some embodiments;

FIG. 7 illustrates an energy, where the acoustic device generates acoustic waves in a direction orthogonal to a cation flow, in accordance with some embodiments;

FIGS. 8A-8C illustrate energy devices, acoustic devices, and coupling agents, wherein the acoustic device comprises a dimension smaller than the corresponding dimension of the coupling agent, and the acoustic device can be positioned relative to the energy device, in accordance with some embodiments;

FIGS. 9A-9C illustrate energy devices, acoustic devices, and coupling agents, wherein the acoustic device comprises a dimension similar to the corresponding dimension of the coupling agent, and the acoustic device can be positioned relative to the energy device, in accordance with some embodiments;

FIGS. 10A-10C illustrate energy devices, acoustic devices, and coupling agents, wherein the acoustic device and the coupling agent are smaller than the energy device with respect to a dimension, in accordance with some embodiments;

FIGS. 11A-11C illustrate energy devices, acoustic devices, and coupling agents, wherein the energy devices, coupling agents, and acoustic devices have different dimensions, in accordance with some embodiments;

FIGS. 12A-12C show a top-down view of the acoustic device and energy device, in accordance with some embodiments;

FIGS. 13A-13C illustrate configurations of an energy device in operable communication with a pair of acoustic devices, in accordance with some embodiments;

FIGS. 14A-14C illustrate configurations of an energy device in operable communication with a pair of acoustic devices, in accordance with some embodiments;

FIGS. 15A-15D illustrate configurations of an acoustic device coupled to an energy device having a cylindrical shape, in accordance with some embodiments;

FIGS. 16A-16H illustrate configurations of multiple acoustic devices coupled to an energy device having a cylindrical shape, in accordance with some embodiments;

FIGS. 17A-17L illustrate configurations of (A) low-temperature shaped batteries, (B) D-shaped batteries, (C) round lipo batteries, (D) rectangular batteries, (E) ultrathin batteries, (F) curved batteries, (G) ultranarrow batteries, (H) C-shaped batteries, (I) hexagonal batteries, (J) L-shaped batteries, (K) triangular batteries, and (L) polygonal batteries, in accordance with some embodiments;

FIG. 18 illustrates a computer system in communication with the acoustic devices, acoustic modules, and energy devices, in accordance with some embodiments;

FIG. 19 illustrates a graph of voltage in volts (V) on the y-axis as a function of capacity in amp-hours (Ah) on the x-axis of devices with or without the acoustic devices, in accordance with some embodiments; and

FIG. 20 illustrates a graph of voltage in volts (V) on the y-axis as a function of capacity in amp-hours (Ah) on the x-axis of devices with or without the acoustic devices, in accordance with some embodiments.

### DETAILED DESCRIPTION

While various embodiments have been shown and described herein, it will be obvious to those skilled in the art that such embodiments are provided by way of example only. Numerous variations, changes, and substitutions may occur to those skilled in the art without departing from the present disclosure. It should be understood that various alternatives to the embodiments described herein may be employed.

Unless defined otherwise, all technical and scientific terms used herein have the same meaning as commonly understood by one of ordinary skill in the art to which the present disclosure belongs. In case of conflict, the present application including the definitions will control. Also, unless otherwise required by context, singular terms shall include pluralities and plural terms shall include the singular.

Reference will not be made in detail to exemplary embodiments of the disclosure, examples of which are illustrated in the accompanying drawings. Wherever possible, the same reference numbers will be used throughout the drawings and disclosure to refer to the same or like parts. The following is an overview of the contents in this disclosure:
I. General
II. Acoustic Device
II.A. Acoustic Wave Generator
II.B. Housing
III. Dimensions
IV. Multiple Acoustic Devices
V. Coupling Agent
VI. Mounting Surface
VII. Energy Systems
VIII. Computer Systems
IX. Methods

### I. General

The Li-ion batteries are the power sources of electric vehicles (EVs), portable tools, and consumer electronics. To fully adopt EVs, recharge the battery as fast as refueling a gas tank vehicle becomes an urgent requirement. The current fastest EV takes up to 30 min to reach 80% state of charge (SOC). In the battery industry, 15 mins (4 C) charging up to 80% SOC is fast charging target. The extreme fast charge (XFC) mandates a charging time of less than 10 mins (charging rate of about 6 C or greater). 1 C, as used herein, generally means that the energy device (e.g., a battery) is charged from 0 to 100% in one hour. Charging time t can generally be calculated by t=60 min/C rate. Future technologies like Li metal anode-based batteries can double the energy density of rechargeable batteries compared to current graphite-based lithium ion (Li-ion) batteries. Li metal batteries, however, during charging, Li ions may deposit and form dendrites that limit its full commercialization. The growth and accumulation of the Li dendrites increase the overall surface area of the electrode, which may result in significant volume expansion and increase in electrode porosity. The increase in electrode volume and porosity allows for electrolyte uptake into the electrode, decreasing performance (e.g., coulombic efficiency) over time. The loss in coulombic efficiency (CE) can cause the continuous consumption of electrolytes, and the loss of active lithium can lead to short battery life when limited Li is used to achieve high energy density. The Li-ion batteries face the same challenges, since Li ions may deposit and form dendrites on graphite anode under fast charging conditions.

The root of these problems lies in non-uniform Li-ion flux, which can lead to a Li-ion concentration gradient, thus resulting in insufficient Li-ion diffusion rate inside a battery. The non-uniform Li-ion flux, concentration gradient, and slow Li-ion diffusion cause very high current density at the local area, which pushes the anode potential to <0 V vs. Li⁺/Li, enabling Li metal plating. The non-uniform Li-ion flux can generate uneven Li metal deposition and growth. Li plating may form Li dendrites. Once the dendrite penetrates the separator and shorts the cathode and the anode, the cell is prone to undergo thermal runaway with a high risk of catching fire or exploding. Even the plated Li doesn't short the cell, it may react with electrolytes to form more or thicker solid electrolyte interface (SEI). The electrolyte and active Li are consumed, degrading the battery's cycle life.

When the current density is high, the Li ions near the electrode surface can be quickly consumed for deposition. However, due to the relatively slower diffusion rate of Li ions in the electrolyte, the Li-ion supply rate is slower than the Li-ion consumption rate near the electrode, leading to a strong Li-ion concentration gradient and non-uniform Li-ion distribution. The higher current densities can promote more non-uniform Li deposition and the formation of more Li dendrites. Similar challenges are observed when the battery is operated at low temperature since the Li-ion diffusion will be slower and the concentration gradient may be more severe than operated at room temperature.

If Li ions distribute uniformly, the Li-ion diffusion rate can be effectively improved, and the Li-ion concentration gradient can be homogenized. Thus, Li ions can fully go into the host or deposit uniformly on the electrode surface, as opposed to forming dendritic structures or protrusions.

Provided herein are devices, systems, and methods for improving energy device performance. The energy device may be, for example, an energy storage and/or energy producing device (e.g., a battery, electrochemical cell, fuel cell, and the like). For instance, the devices of the present disclosure can reduce charging time, increase charging cycles, improve energy storage, extend the lifetime of an energy device, and decrease safety risks associated with energy devices. Provided herein in some embodiments are acoustic modules. An acoustic module can be in communication with the energy device. An acoustic module can comprise an acoustic device or a plurality of acoustic devices. The acoustic device can comprise an acoustic wave generator configured to generate acoustic waves and a housing enclosing the acoustic wave generator. The housing of the acoustic device can be attached to an external surface of the energy device in a way that permits the acoustic waves to be streamed into the energy device. The acoustic module can comprise a controller. The controller can control the acoustic device to stream the acoustic waves into the energy device. In some cases, the acoustic device is provided in a quantity based at least on a cell geometry and/or energy device pack design of the energy device, for optimizing improvements in the energy device performance.

The energy devices herein can provide and/or store energy depending on when energy consumption is desired. For example, the energy devices herein can provide or store energy as a battery. The batteries can be lithium-ion batteries, such as those found in personal electronics (e.g., phones, laptops, other devices), personal vehicles (e.g., an electric vehicle), or a commercial vehicle (e.g., freight). In some cases, the batteries can be lithium-metal batteries (i.e., LMBs). In some cases, the batteries can be sodium-metal batteries (i.e., NMBs). In some cases, the batteries can be sodium-ion batteries (i.e., NIBs). In some cases, the batteries can be zinc-ion batteries (i.e., ZIBs).

In some instances, the energy devices can be apparatuses that generate chemical forms of energy, such as in fuel cells. The fuel cells can be a hydrogen fuel cell, molten carbonate fuel cell, methanol/oxygen fuel cell, and the like. The fuel cells can be integrated along with the acoustic devices as described herein into personal vehicles, commercial vehicles, energy recycling plants, or other apparatuses that utilize fuel cells. Furthermore, the energy devices can be electrochemical cells that can output chemical forms of energy (e.g., hydrogen fuel) or electrical energy.

The acoustic modules or acoustic devices may be integrated with energy devices to form energy units. The energy units may be combined and/or scaled up to provide a source of energy for any of the end-use application devices and systems as described herein, while providing a source of acoustic waves to improve energy device performance.

An energy device can comprise a plurality of electrodes, such as a first electrode and a second electrode. The first electrode and the second electrode can each be a cathode or an anode. In some embodiments, the first electrode and the second electrode can have a gap between the first electrode and the second electrode. An energy device can comprise a separator. The electrode gap can be filled with an electrolyte. Optionally, a separator may be placed within the electrode gap. In some embodiments, the separator can be at any location of the gap. In some embodiments, the separator may be equidistant from the cathode and the anode. When present, the separator can comprise a porous material to enable ion transport from and/or between the electrodes and across the electrode gap.

In some aspects, provided herein are methods for assembling an energy system, the method comprises providing at least one acoustic device comprising (1) an acoustic wave generator and (2) a housing enclosing the acoustic wave generator; and operably coupling the at least one acoustic device to an energy device to construct the energy system, by attaching the housing of the at least one acoustic device to an external surface of the energy device. The method can further comprise incorporating the energy system into one or more products. In some cases, the method can further comprise using at least one controller to control the acoustic wave generator to generate acoustic waves for streaming into the energy device to improve energy device performance for the one or more products.

The acoustic device as described herein can extend energy device (e.g., battery) life and improve energy device (e.g., battery) performance in several ways. First, the acoustic device can suppress Li ion concentration gradient (i) in a bulk electrolyte and/or (ii) in pores of at least one electrode of the energy device. The acoustic device, via generated acoustic waves, can suppress counter anion concentration gradient (i) in a bulk electrolyte and/or (ii) in pores of at least one electrode of the energy device. Furthermore, the acoustic device can facilitate (i) Li ion diffusivity in a bulk electrolyte, (ii) at an electrolyte and electrode interface, and/or (iii) in an electrode of the energy device. In some cases, the acoustic device can suppress dendritic Li formation and promote dense large Li particle formation in the energy device (e.g., LMBs) via the generated acoustic waves. In some cases, the acoustic device can also promote Li transport into an anode material of the energy device (e.g., LIBs). The acoustic device can mitigate volume swelling or expansion of a cell in the energy device as the energy device undergoes multiple charge cycles.

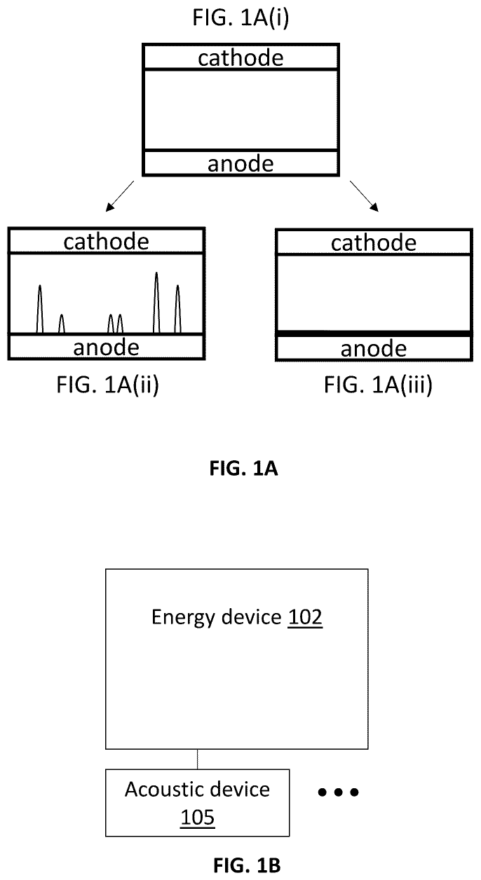

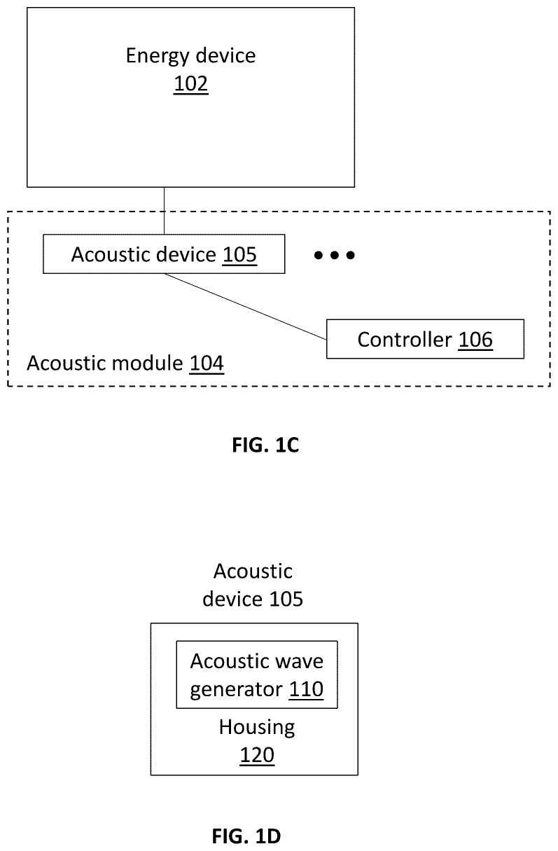

Without being bound by any particular theory, an energy device in communication with an acoustic device as described herein exhibits improved performance. As illustrated in FIG. 1A(i), an energy device can comprise a plurality of electrodes, such as a cathode and an anode, and an electrode gap interspaced between the plurality of electrodes. During a charging event, Li ions are mobilized and travel from one electrode (e.g., the cathode) to the other electrode (e.g., the anode). As illustrated in FIG. 1A(ii), under fast charging or over many cycles of charge and discharge, an inhomogeneous Li ion concentration can develop across the electrode gap. Overtime, as illustrated in FIG. 1A(ii), deposited lithium ions form dendrites across the electrode gap, resulting in a porous anode (i.e., Li ions can be redistributed from the electrodes into the bulk as protrusions, e.g., dendrimers). In some cases, the deposited lithium ion dendrites may establish a channel between the plurality of electrodes, resulting in a short-circuit event. Additionally, over multiple cycles of charge and discharge, a thick solid electrolyte interface (SEI) may form over the anode, preventing efficient Li ion transport across the electrodes.

By contrast, integrating the acoustic modules as described herein (e.g., in FIG. 1A(iii)), may eliminate, reduce or modulate the formation of lithium deposits, e.g., dendrites, throughout the electrode gap. For example, the surface acoustic waves (SAWs) from the acoustic module induce a fluid flow across the electrode gap, resulting in a homogeneous lithium ion concentration throughout the electrode gap. Under fast charging and/or over many cycles of charge and discharge, the energy device with the acoustic module, as in FIG. 1A(iii), exhibits little to no lithium dendrite formation and maintains a dense SEI over the anode.

The acoustic devices, systems, and methods may be used and integrated into energy devices, such as battery cells, fuel cells, or electrochemical cells. The energy devices, in turn, can be used or integrated into energy systems, such as batteries, battery modules, battery packs, and the like. The energy systems can be integrated or incorporated into products, such as electric vehicles, consumer electronics (e.g., mobile devices and/or laptops), power tools, phone batteries, energy generators, energy storage systems, electric vertical take-off and landing aircrafts (eVTOLs), drones, manned aircraft, unmanned aircraft, delivery robots, e-bicycles, e-scooters, robotics or robots, and the like. For example, the acoustic module may be integrated into a lithium ion battery used to power a vehicle, e.g., a sedan, a freight vehicle, and the like. The acoustic device may be integrated adjacent to the energy device, e.g., a lithium ion battery, after the energy device has been manufactured. For example, a consumer may integrate the acoustic device onto the energy device of the consumer's personal vehicle or other electronic device, thus illustrating the benefit of portability and ease of installation. The consumer may attach or fix the acoustic device onto the energy device via the housing of the acoustic device.

### II. Acoustic Device

The acoustic devices of the present disclosure can generate surface acoustic waves (SAWs). The SAWs can agitate molecules within an energy device to perturb the local environment, thus preventing the formation of dendrites (e.g., Li dendrites). For example, the SAWs can agitate electrolytes in an energy device (e.g., a battery), thereby perturbing the formation of intermolecular Li—Li bonds. The acoustic device can house an acoustic wave generator within a housing. The acoustic device may generate SAWs of a frequency and power to agitate or perturb local ions, such as local Li ions at an interface, such as an interface between an electrode gap and an electrode.

The acoustic device can generate SAWs that propagate through a housing of the acoustic device to the energy device. In some aspects, the acoustic device can generate SAWs that propagate through a medium and to the energy device.

The direction of the SAWs can be altered by the controller. The SAWs may stream into the energy device in a direction parallel to an electrode gap interspaced between the electrodes of the energy device. The SAWs may stream into the device in a direction parallel or coaxial with the direction that Li ions travel during charging or discharging events. The acoustic device comprises an acoustic wave generator configured to emit (e.g., stream) acoustic waves. The acoustic wave generator is configured to generate the acoustic waves to trigger microscale or nanoscale acoustofluidics in a presence of a fluid located within the energy device.

FIGS. 1B-1D illustrate an acoustic device 105 in accordance with some embodiments. An acoustic device as described herein can refer to any apparatus, device, or system that is designed, configured, or used for transmitting acoustic waves into a device, e.g., an energy device 102. The energy device can be external to the acoustic device. The acoustic device can be in communication with the energy device, as illustrated in FIG. 1B. In some embodiments, a plurality of acoustic devices may be in communication with the energy device.

An advantage of configuring the acoustic device for use externally to an energy device is that it can enable the acoustic device to be easily integrated with the energy device. In contrast, internally integrating the acoustic device into the energy device would increase the cost of manufacturing and add the complication of wiring, positioning, and separating the acoustic device from the internal circuitry of the energy device. By configuring the acoustic module for use external to the energy device, the energy device may be manufactured separately from the acoustic device. Accordingly, decoupling the processes of energy device manufacture and acoustic device manufacture allows for greater flexibility of arrangements of the acoustic device and energy device and also decreases costs of manufacture, especially with respect to the manufacture of energy devices because it removes an additional element from the manufacture process.

Additional advantages of the acoustic modules and acoustic devices of the present disclosure include increasing charge cycles, increasing energy storage, increasing an energy device lifetime, and improving safety. The acoustic module and the acoustic device(s) may increase charge cycles by at least about 1.5× (times), at least about 2×, at least about 3×, at least about 4×, at least about 5×, at least about 6×, at least about 7×, at least about 8×, at least about 9×, at least about 10×, or more of standard energy devices in the market (e.g., commercially available batteries). The acoustic module and the acoustic device(s) may increase an energy storage or an energy density of the energy device by at least about 1.5×, at least about 2×, at least about 3×, at least about 4×, at least about 5×, at least about 6×, at least about 7×, at least about 8×, at least about 9×, at least about 10×, or more of standard energy devices in the market. The acoustic module and the acoustic device(s) may increase an energy device lifetime by at least about 1.5×, at least about 2×, at least about 3×, at least about 4×, at least about 5×, at least about 6×, at least about 7×, at least about 8×, at least about 9×, at least about 10×, or more of standard energy devices in the market. The acoustic modules and acoustic devices may improve safety by mitigating risks associated with energy device use, such as shorting and combustion of device components upon exposure to air and/or moisture.

The acoustic module and acoustic devices provided herein may improve charging characteristics, such as decreasing charge time and/or increasing energy storage or energy density. For instance, the acoustic module may decrease charge time by at least about 10%, at least about 20%, at least about 30%, at least about 40%, at least about 50%, at least about 60%, at least about 70%, at least about 80%, at least about 90%, at least about 95%, or more as compared to an energy device without the acoustic module or acoustic device. In some instances, the acoustic module may increase energy density by at least about 10%, at least about 20%, at least about 30%, at least about 40%, at least about 50%, at least about 60%, at least about 70%, at least about 80%, at least about 90%, at least about 95%, or more of an energy device without the acoustic module or acoustic device. At any given point in time, an energy device with the acoustic module or acoustic device of the present disclosure may exhibit at least about 1.5× (times), at least about 2×, at least about 3×, at least about 4×, at least about 5×, at least about 6×, at least about 7×, at least about 8×, at least about 9×, at least about 10×, or more, higher energy density in comparison to an energy device without the acoustic module or acoustic device.

An energy device with the acoustic module or acoustic device of the present disclosure may comprise an energy density of at least about 50 Wh/kg, at least about 100 Wh/kg, at least about 150 Wh/kg, at least about 200 Wh/kg, at least about 250 Wh/kg, at least about 300 Wh/kg, at least about 350 Wh/kg, at least about 400 Wh/kg, at least about 450 Wh/kg, at least about 500 Wh/kg, at least about 550 Wh/kg, at least about 600 Wh/kg, or more. The energy device with the acoustic module or acoustic device of the present disclosure may comprise an energy density of at least about 50 Wh/kg to about 100 Wh/kg, about 150 Wh/kg to about 200 Wh/kg, about 250 Wh/kg to about 300 Wh/kg, about 350 Wh/kg to about 400 Wh/kg, about 450 Wh/kg to about 500 Wh/kg, or about 550 Wh/kg to about 600 Wh/kg. The energy device with the acoustic module or acoustic device of the present disclosure may store at least about 50 Wh/kg, at least about 100 Wh/kg, at least about 150 Wh/kg, at least about 200 Wh/kg, at least about 250 Wh/kg, at least about 300 Wh/kg, or more energy than an energy device without the acoustic module or acoustic device.

An acoustic module 104 in communication with an energy device 102 is illustrated in FIG. 1C. The acoustic module can comprise an acoustic device 105 and a controller 106. The controller can be in electronic communication with the acoustic device. The controller can modulate or control the output of the acoustic device, such as generated acoustic waves. The controller can manipulate a generated frequency, power, attenuation length, and other parameters of the acoustic waves. The controller can simultaneously control the outputs of multiple acoustic devices within the acoustic module.

### II. A. Acoustic Wave Generator

The acoustic wave generator generates waves, such as acoustic waves. The generated acoustic waves can permeate a medium, such as a fluid, to agitate the medium or particles within the medium. For example, an energy device may comprise an electrolyte, and the acoustic waves may agitate the electrolytes.

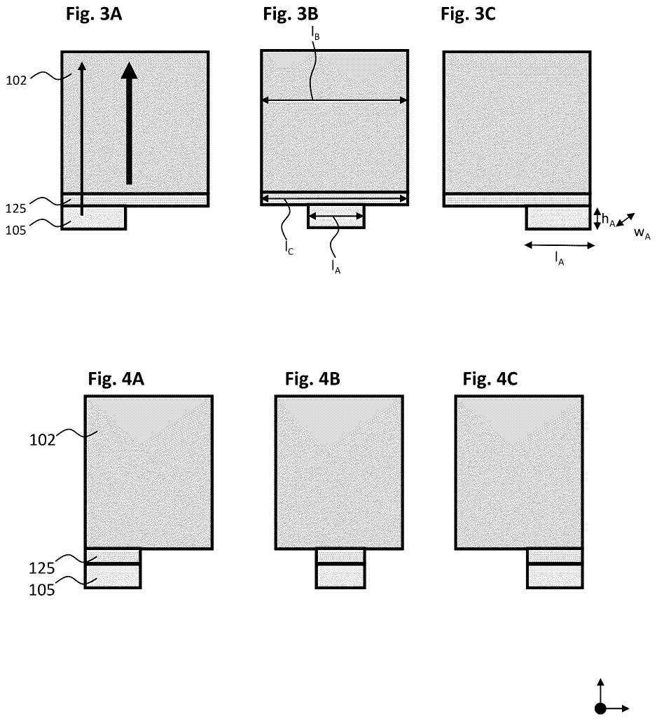

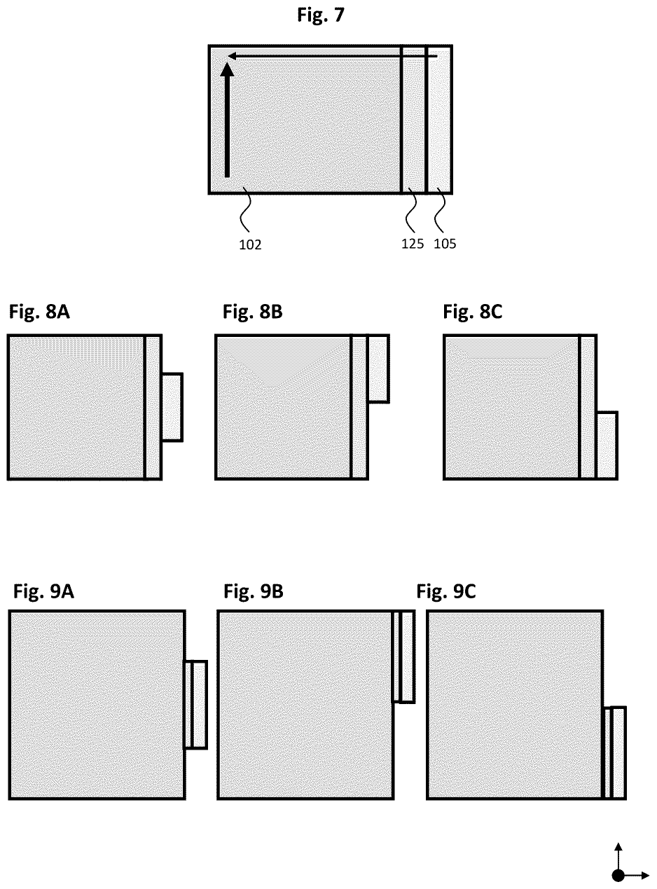

The generated acoustic waves may propagate (e.g., stream) in a plurality of directions. Within an energy device, the acoustic waves may propagate along one axis, two axes, or three axes of the energy device. For example, if the energy device comprises a pair of electrodes configured to charge or discharge, the acoustic waves may be propagated coaxially, parallel, antiparallel, orthogonal, or a combination thereof, to the direction of cation (e.g., Li⁺, Na⁺, Mg²⁺, Zn⁺) flow. As illustrated generally in FIGS. 3A and 7, cations can flow along a length (e.g., a y-axis) of the energy device, such as along an electrode gap in the energy device. The direction of cation flow (e.g., thick arrow in FIGS. 3A and 7) may be parallel to (as shown in FIG. 3A) or orthogonal to (as shown in FIG. 7) to the direction of the acoustic waves (thin arrows).

The acoustic wave generator can comprise a mechanism configured to generate acoustic waves. The acoustic wave generator can comprise a piezoelectric material. The piezoelectric material can include lithium niobate (LiNbO₃), lithium titanate (Li₂TiO₃), barium titanate (BaTiO₃), lead zirconate titanate (Pb(ZrₓTi₁₋ₓ)O₃ wherein (0≤x≤1)), quartz, aluminum nitride (AlN), langasite, lead magnesium niobate-lead titanate (PMN-PT), lead-free potassium sodium niobate (K_{0.5}Na_{0.5}NbO₃ or KNN), a doped derivative of lead-free potassium sodium niobate, and/or polyvinylidene fluoride (PVDF).

The energy of the acoustic waves may induce acoustic streaming in the energy device. Acoustic streaming may be a non-laminar and/or turbulent fluid flow, which may maximize the agitation of the electrolyte and/or the homogenization of the distribution of the cations in the electrolyte. It should be appreciated that acoustic streaming may result from interplay between variations in a density of the electrolyte and variations in a velocity of the electrolyte. A frequency of the acoustic waves, an amplitude of the acoustic waves, and/or the viscosity of the electrolyte may determine whether the acoustic waves are able to induce acoustic streaming in the electrolyte. Acoustic streaming may be achieved at lower frequencies of the acoustic waves, for example, when the viscosity of the electrolyte is between a certain range. For example, acoustic streaming may be induced in water, which may have a viscosity of 0.890 centipoise at 25° C., when the frequency of the acoustic waves exceeds 1 megahertz (1 MHz).

The acoustic waves can be surface acoustic waves (SAW). The SAWs can comprise one or more wave types. The one or more wave types can comprise leaky SAW, love wave, Bleustein Gulyaev wave, surface skimming bulk wave, surface transverse waves, or any combination thereof. In some instances, the acoustic wave can comprise a bulk wave selected from the group consisting of thickness mode wave, thickness shear mode wave, longitudinal bulk wave, and any combination thereof.

Within the acoustic module, the controller can be provided separately from the acoustic device. In some instances, the controller can be integrated onboard the acoustic device. The controller can be in wireless communication with the acoustic device. Alternatively, the controller can be electronically coupled to the acoustic device.

The controller can control the acoustic wave generator to generate the acoustic waves at a frequency ranging from 10 Hz to 500 MHz. The generated acoustic waves can comprise a frequency ranging from about 100 Hz to about 400 MHz, from about 200 Hz to about 300 MHz, from about 300 Hz to about 200 MHz, from about 400 Hz to about 100 MHz, or from about 500 Hz to about 0.5 MHz. The frequency (fs) of the generated acoustic waves may be selected based on a desired length of the acoustic waves, as determined by the equation:

$${λ}_{A W} = \frac{{c}_{s}}{{f}_{s}} \qquad ( eq . 1 )$$

wherein cₛ corresponds to the speed of light traveling through the medium (e.g., an electrode or an electrolyte of the energy device, or other components of the present disclosure) and λ_{AW} corresponds to a wavelength of the acoustic waves.

The one controller can control the acoustic wave generator to generate the acoustic waves with a power ranging from 0.1 mW to 500 MW. The power of the generated acoustic waves can range from about 0.1 mW to about 500 MW, from about 0.2 mW to about 250 MW, from about 0.5 mW to about 100 MW, from about 1.0 mW to about 50 MW, from about 5.0 mW to about 25 MW, from about 10 mW to about 10 MW, from about 50 mW to about 1 MW, from about 100 mW to about 0.5 MW, or from about 20 0 mW to about 250 W. The power of the generated waves can prevent the formation of metal deposits (e.g., Li deposits) without structurally perturbing the components within the energy device.

In some embodiments, the controller is configured to control the acoustic wave generator to generate the acoustic waves having one or more waveforms selected from the group consisting of continuous sine wave, square wave, and triangular wave. In some embodiments, the controller is configured to control the acoustic wave generator to generate the acoustic waves with on/off pulsing ranging from 0% to 100%. In some embodiments, the controller is configured to control the acoustic wave generator to generate the acoustic waves with on/off pulsing ranges from about 0% to about 10%, about 0% to about 20%, about 0% to about 30%, about 0% to about 40%, about 0% to about 50%, about 0% to about 60%, about 0% to about 70%, about 0% to about 80%, about 0% to about 90%, about 0% to about 100%, about 10% to about 20%, about 10% to about 30%, about 10% to about 40%, about 10% to about 50%, about 10% to about 60%, about 10% to about 70%, about 10% to about 80%, about 10% to about 90%, about 10% to about 100%, about 20% to about 30%, about 20% to about 40%, about 20% to about 50%, about 20% to about 60%, about 20% to about 70%, about 20% to about 80%, about 20% to about 90%, about 20% to about 100%, about 30% to about 40%, about 30% to about 50%, about 30% to about 60%, about 30% to about 70%, about 30% to about 80%, about 30% to about 90%, about 30% to about 100%, about 40% to about 50%, about 40% to about 60%, about 40% to about 70%, about 40% to about 80%, about 40% to about 90%, about 40% to about 100%, about 50% to about 60%, about 50% to about 70%, about 50% to about 80%, about 50% to about 90%, about 50% to about 100%, about 60% to about 70%, about 60% to about 80%, about 60% to about 90%, about 60% to about 100%, about 70% to about 80%, about 70% to about 90%, about 70% to about 100%, about 80% to about 90%, about 80% to about 100%, or about 90% to about 100%. In some embodiments, the controller is configured to control the acoustic wave generator to generate the acoustic waves with on/off pulsing ranges from about 0%, about 10%, about 20%, about 30%, about 40%, about 50%, about 60%, about 70%, about 80%, about 90%, or about 100%. In some embodiments, the controller is configured to control the acoustic wave generator to generate the acoustic waves with on/off pulsing ranges from at least about 0%, at least about 10%, at least about 20%, at least about 30%, at least about 40%, at least about 50%, at least about 60%, at least about 70%, at least about 80%, at least about 90%, or more. In some embodiments, the controller is configured to control the acoustic wave generator to generate the acoustic waves with on/off pulsing ranges from at most about 10%, at most about 20%, at most about 30%, at most about 40%, at most about 50%, at most about 60%, at most about 70%, at most about 80%, at most about 90%, or at most about 100%.

In some embodiments, the controller is configured to control the acoustic wave generator to generate the acoustic waves with a timescale period ranging from about 1 microsecond (μs) to about 1 millisecond (ms). The timescale period can range from about 1 μs to about 10 μs, about 1 μs to about 50 μs, about 1 μs to about 100 μs, about 1 μs to about 250 μs, about 1 μs to about 500 μs, about 1 μs to about 750 μs, about 1 μs to about 1,000 μs, about 10 μs to about 50 μs, about 10 μs to about 100 μs, about 10 μs to about 250 μs, about 10 μs to about 500 μs, about 10 μs to about 750 μs, about 10 μs to about 1,000 μs, about 50 μs to about 100 μs, about 50 μs to about 250 μs, about 50 μs to about 500 μs, about 50 μs to about 750 μs, about 50 μs to about 1,000 μs, about 100 μs to about 250 μs, about 100 μs to about 500 μs, about 100 μs to about 750 μs, about 100 μs to about 1,000 μs, about 250 μs to about 500 μs, about 250 μs to about 750 μs, about 250 μs to about 1,000 μs, about 500 μs to about 750 μs, about 500 μs to about 1,000 μs, or about 750 μs to about 1,000 μs. The timescale period can be about 1 μs, about 10 μs, about 50 μs, about 100 μs, about 250 μs, about 500 μs, about 750 μs, or about 1,000 μs. The timescale period can be at least about 1 μs, about 10 μs, about 50 μs, about 100 μs, about 250 μs, about 500 μs, or about 750 μs. The timescale period can be at most about 10 μs, about 50 μs, about 100 μs, about 250 μs, about 500 μs, about 750 μs, or about 1,000 μs.

### II.B. Housing

As illustrated in FIG. 1D, the housing 120 of the acoustic device 105 can enclose the acoustic wave generator 110. The housing is made of a material that allows acoustic waves from the acoustic wave generator to transmit through. The housing enables safe storage of the acoustic wave generator, which, in turn, makes the acoustic device portable. The housing provides separation between the acoustic wave generator and the controller. The housing can propagate the generated waves from the acoustic wave generator outward from the acoustic device. The housing can interface with the energy device via an external surface of the energy device. The housing can be open at one end. In some cases, the open end may be coupled to the battery. In some cases, when the open end is coupled to the battery, the surface acoustic waves may directly propagate into the energy device. In some cases, the housing can be closed at the one end such that the housing wholly encloses the acoustic device.

The housing can comprise a cover and a base, which together form an enclosure. The enclosure can hold the acoustic device (or multiple acoustic devices). The cover and the base can be held together via a physical mechanism. For example, physical mechanisms for holding the cover and the base together can include snapfits, ultrasonic welding, nuts and bolts, rivets, screws, nails, locks, latches, wires, joints, soldering, welding, gluing and the like. In some alternative embodiments, the base and housing cover can be monolithically and collectively formed as a single component.

The housing can be made of a material that is resistant to normal wear-and-tear, weather, or other external forces. The housing can also resist changes in atmospheric pressure. The housing of the acoustic device can be ergonomically designed to form a seal with the planar or non-planar surface of the energy device. For instance, the housing may be designed to enable easy or one-step assembly (or assembly with few steps) with respect to an energy device.

### III. Dimensions

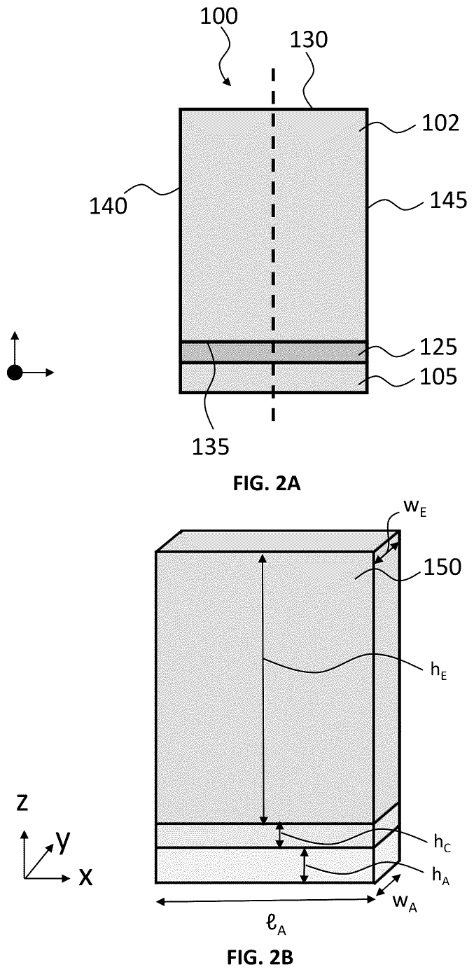

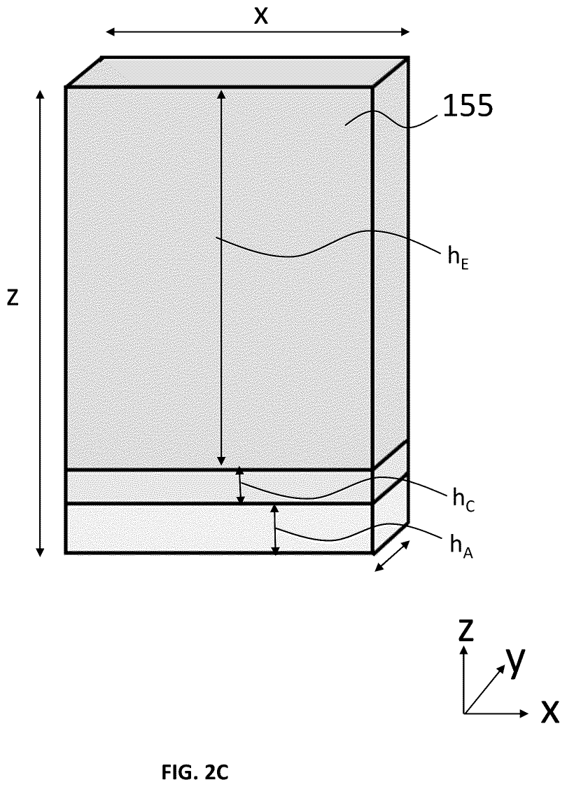

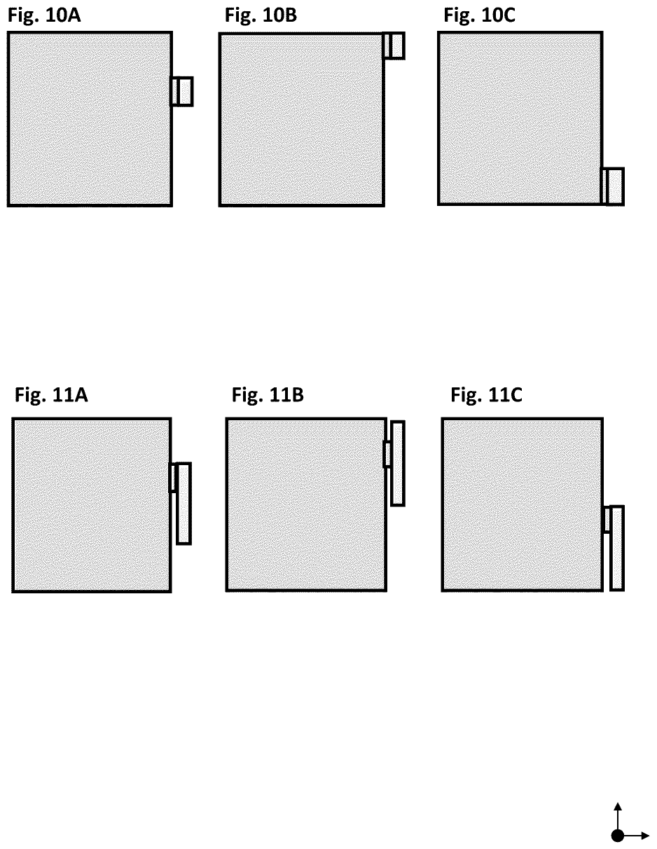

The acoustic device can comprise dimensions relative to the energy device. The energy device can comprise a first energy device dimension, a second energy device dimension, and a third energy device dimension. In some instances, each of the first energy device dimension, the second energy device dimension, and the third energy device dimension can independently be a length (l_{E}), width (w_{E}), and height (h_{E}) as described herein. The acoustic device can comprise a first acoustic device dimension (e.g., a length (l_{A})), a second acoustic device dimension (e.g., width (w_{A}) or thickness), and third acoustic device dimension (e.g., a height (h_{A})), as generally illustrated in FIGS. 2A-15D. The length of a component corresponds to a distance along the y-axis, as generally illustrated in FIGS. 2A-15D, though a skilled artisan will appreciate that the coordinate system used herein is arbitrary and used to describe a relative orientation or dimension. The length of a component corresponds to a distance along the x-axis, as generally illustrated in FIGS. 2A-15D. Together, the x-axis and y-axis define an xy-plane that corresponds to a lateral plane or a basal plane of the energy device. In some cases, the third dimension, such as the height of the energy device (h_{E}), corresponds to a distance along the z-axis, which runs perpendicular to the xy-plane, as generally illustrated in FIGS. 2A-15D. The height of the energy device (h_{E}) is defined as the distance between a top 130 and a bottom 135 of the energy device, as shown in FIG. 2A. The length of the energy device (l_{E}) is defined as the distance between a first side 140 and a second side 145 of the energy device, as shown in FIG. 2A. The width of the energy device (w_{E}) is defined as the distance between a front face 150 and a back face 155 of the energy device, as shown in FIGS. 2B and 2C. However, a skilled artisan will appreciate that length and width may be used interchangeably to define the dimensions within the xy-plane.

For example, the acoustic device can comprise a first acoustic device dimension, a second acoustic device dimension, and a third acoustic device dimension. In some cases, when present, the coupling agent can comprise a first coupling agent dimension, a second coupling agent dimension, and a third coupling agent dimension. In some cases, the energy device can comprise a first energy device dimension, a second energy device dimension, and a third energy device dimension. In some instances, the first acoustic device dimension, the first coupling agent dimension, and the first energy device dimension can be along the same axis. In some cases, at least two of the first acoustic device dimension, the first coupling agent dimension, and the first energy device dimension can be along the same axis. In some instances, each of the first acoustic device dimension, the first coupling agent dimension, and the first energy device dimension can be along different axes. For example, and not by limitation, the first acoustic device dimension can be a length of the acoustic module (l_{A}). In some instances, the length of the acoustic device (l_{A}) corresponds to the distance extending from a first side of the acoustic device to a second side of the acoustic device. In some cases, the second acoustic device dimension can be a width of the acoustic device (w_{A}). The width of the acoustic device (w_{A}) can be defined as the distance between a front face and a back face of the acoustic device. In some cases, the third acoustic device dimension can be a height of the acoustic device (h_{A}). The height of the acoustic device (h_{A}) can be defined as the distance between a top of the acoustic device and a bottom of the acoustic device.

When present, the coupling agent comprises a plurality of dimensions. In some cases, the coupling agent comprises a coupling agent length (l_{C}), a coupling agent width (w_{C}), and a coupling agent height (h_{C}). The length (l_{C}) corresponds to the distance extending from a first side of the coupling agent to a second side of the coupling agent. The height of the coupling agent (h_{C}) corresponds to the distance between a top of the coupling agent and a bottom of the coupling agent. The width of the coupling agent (w_{C}) is defined as the distance between a front face and a back face of the coupling agent.

The acoustic module can comprise an acoustic device that can comprise a same dimension as the energy device along at least one axis. In some instances, the acoustic module can comprise a different dimension from the energy device along at least one axis. For example, the magnitude of the first acoustic device dimension (e.g., a length of the acoustic module (l_{A})) can be relative to the magnitude of the first energy device dimension (e.g., a length of the energy device (l_{E})). In some instances, the first acoustic module dimension (e.g., l_{A}) ranges from about 0.0001% to about 100% of a length of the energy device (l_{E}). The first acoustic module dimension (e.g., l_{A}) can be about the same as the first energy device dimension (e.g., l_{E}). In some cases, the first acoustic module dimension is about 100% of the first energy device dimension. In some cases, the first acoustic module device dimension can be at least about 0.0001% of the first energy device dimension. In some cases, the first acoustic module device dimension can be at least about 0.001% of the first energy device dimension. In some cases, the first module device dimension can be about 0.0001% of the first energy device dimension. In some cases, the first module device dimension can be at most 100% the first energy device dimension. In some cases, the first module device dimension can be about 0.0001%, about 0.0005%, about 0.001%, about 0.005%, about 0.01%, 0.05%, 0.1%, about 0.5%, about 1.0%, about 5.0%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the first energy device dimension. In some cases, the first module device dimension can be from about 0.0001% to about 0.1%, from about 0.0005% to about 0.5%, from about 0.001% to about 1%, from about 0.005% to about 2%, from about 0.01%, to about 5%, from about 0.05% to about 10%, or from about 1% to about 100% of the first energy device dimension.

Optionally or when present, the first coupling agent dimension (e.g., a length of the coupling agent (l_{C})) can be relative to the first energy device dimension (e.g., a length of the energy device (l_{E})). For example, the first coupling agent direction can range from about 0.0001% to about 100% of the first energy device dimension. In some cases, the first coupling agent dimension (e.g., a length of a coupling agent (l_{C})) can be about the same as the first energy device dimension (e.g., a length of the energy device (l_{E})). In some cases, the first coupling agent dimension can be at least about 0.0001% of the first energy device dimension. In some cases, the first coupling agent dimension can be about 0.0001% of the first energy device dimension. In some cases, the first coupling agent direction can be at most 100% the first energy device dimension. In some cases, the first coupling agent direction can be about 0.0001%, about 0.0005%, about 0.001%, about 0.005%, about 0.01%, 0.05%, 0.1%, about 0.5%, about 1.0%, about 5.0%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% the first energy device dimension. In some cases, the first coupling agent dimension can be from about 0.0001% to about 0.1%, from about 0.0005% to about 0.5%, from about 0.001% to about 1%, from about 0.005% to about 2%, from about 0.01% to about 5%, from about 0.05% to about 10%, or from about 1% to about 100% of the first energy device dimension.

In some instances, the second acoustic module dimension (e.g., a width of the acoustic device (w_{A})) can be relative to the second energy device dimension (e.g., a width of the energy device (w_{E})). For example, the magnitude of the second acoustic module dimension (e.g., the width of the acoustic device (w_{A})) can be relative to the magnitude of the second energy device dimension (e.g., the width of the energy device (w_{E})). In some instances, the second acoustic module dimension ranges from about 0.0001% to about 100% of the second energy device dimension (e.g., the width of the energy device (w_{E})). In some cases, the second acoustic module dimension can be about the same as the second energy device dimension. In some cases, w_{A} may be the same as w_{E}. In some cases, the second acoustic module dimension can be at least about 0.0001% of the second energy device dimension. In some cases, the second acoustic module dimension can be at least about 0.001% of the second energy device dimension. In some cases, the second acoustic module dimension can be at least about 0.01% of the second energy device dimension. In some cases, the second acoustic module dimension can be at least about 0.1% of the second energy device dimension. In some cases, the second acoustic module dimension can be about 0.0001% of the second energy device dimension. In some cases, the second acoustic module dimension can be about 0.0001% of the second energy device dimension. In some cases, the second acoustic module dimension can be about 0.001% of the second energy device dimension. In some cases, the second acoustic module dimension can be about 0.01% of the second energy device dimension. In some cases, the second acoustic module dimension can be about 0.1% of the second energy device dimension. In some cases, the second acoustic module dimension can be about 0.01% of the second energy device dimension. In some cases, the second acoustic module dimension can be at most 100% the second energy device dimension. In some cases, the second acoustic module dimension can be about 0.00001%, about 0.0005%, about 0.001%, about 0.005%, about 0.01%, 0.05%, 0.1%, about 0.05%, about 0.1%, about 0.5%, about 1.0%, about 5.0%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the second energy device dimension. In some cases, the second acoustic module dimension can be from about 0.0001% to about 0.1%, from about 0.0005% to about 0.5%, from about 0.001% to about 1%, from about 0.005% to about 2%, from about 0.01% to about 5%, from about 0.05% to about 10%, or from about 1% to about 100% of the second energy device dimension. In some instances, the second acoustic device dimension is a width (w_{A}), and the second energy device dimension is a width (w_{E}).

Optionally or when present, the second coupling agent dimension can be relative to the second energy device dimension. For example, the second coupling agent dimension (e.g., a width of the coupling agent (w_{C})) can range from about 0.01% to about 100% of the second energy device dimension (e.g., a width of the energy device (w_{E})). In some cases, the second coupling agent dimension can be about the same as the second energy device dimension. In some cases, the second coupling agent dimension can be at least about 0.0001% of the second energy device dimension. In some cases, the second coupling agent dimension can be at least about 0.001% of the second energy device dimension. In some cases, the second coupling agent dimension can be at least about 0.01% of the second energy device dimension. In some cases, the second coupling agent dimension can be at least about 0.1% of the second energy device dimension. In some cases, the second coupling agent dimension can be about 0.0001% of the second energy device dimension. In some cases, the second coupling agent dimension can be about 0.001% of the second energy device dimension. In some cases, the second coupling agent dimension can be about 0.01% of the second energy device dimension. In some cases, the second coupling agent dimension can be about 0.1% of the second energy device dimension. In some cases, the second coupling agent dimension can be at most 100% the second energy device dimension. In some cases, the second coupling agent dimension can be about 0.01%, about 0.05%, about 0.1%, about 0.5%, about 1.0%, about 5.0%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% the second energy device dimension. In some cases, the second coupling agent dimension can be from about 0.0001% to about 0.1%, from about 0.0005% to about 0.5%, from about 0.001% to about 1%, from about 0.005% to about 2%, from about 0.01% to about 5%, from about 0.05% to about 10%, or from about 1% to about 100% of the second energy device dimension.

In some instances, the third acoustic module dimension (e.g., the height of the acoustic module (h_{A})) can be relative to the third energy device dimension (e.g., the height of the energy device (h_{E}). For example, the magnitude of the third acoustic module dimension (e.g., the height of the acoustic device (h_{A})) can be relative to the magnitude of the third energy device dimension (e.g., the height of the energy device (h_{E})). In some instances, third acoustic module dimension ranges from about 0.0001% to about 100% of the third energy device dimension. In some cases, the third acoustic module dimension can be about the same as the third energy device dimension (e.g., h_{A} is about 100% h_{E}). In some cases, the third acoustic module dimension can be at least about 0.0001% of the third energy device dimension. In some cases, the third acoustic module dimension can be at least about 0.001% of the third energy device dimension. In some cases, the third acoustic module dimension can be at least about 0.01% of the third energy device dimension. In some cases, the third acoustic module dimension can be at least about 0.1% of the third energy device dimension. In some cases, the third acoustic module dimension can be about 0.0001% of the third energy device dimension. In some cases, the third acoustic module dimension can be about 0.001% of the third energy device dimension. In some cases, the third acoustic module dimension can be about 0.01% of the third energy device dimension. In some cases, the third acoustic module dimension can be about 0.1% of the third energy device dimension. In some cases, the third acoustic module dimension can be at most 100% the third energy device dimension. In some cases, the third acoustic module dimension can be about 0.01%, about 0.05%, about 0.1%, about 0.5%, about 1.0%, about 5.0%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the third energy device dimension. In some cases, the third acoustic module dimension can be from about 0.0001% to about 0.1%, from about 0.0005% to about 0.5%, from about 0.001% to about 1%, from about 0.005% to about 2%, from about 0.01% to about 5%, from about 0.05% to about 10%, or from about 1% to about 100% of the third energy device dimension.

Optionally or when present, the third coupling agent dimension can be relative to the third energy device dimension. For example, the third coupling agent dimension (e.g., a height of the coupling agent (h_{C})) can range from about 0.0001% to about 100% of the third energy device dimension (e.g., a height of the energy device (h_{E})). In some cases, the third coupling agent dimension can be about the same as the third energy device dimension (i.e., h_{C} is about 100% h_{E}). In some cases, the third coupling agent dimension can be at least about 0.0001% of the third energy device dimension. In some cases, the third coupling agent dimension can be at least about 0.001% of the third energy device dimension. In some cases, the third coupling agent dimension can be at least about 0.01% of the third energy device dimension. In some cases, the third coupling agent dimension can be at least about 0.1% of the third energy device dimension. In some cases, the third coupling agent dimension can be about 0.0001% of the third energy device dimension. In some cases, the third coupling agent dimension can be about 0.001% of the third energy device dimension. In some cases, the third coupling agent dimension can be about 0.01% of the third energy device dimension. In some cases, the third coupling agent dimension can be about 0.1% of the third energy device dimension. In some cases, the third coupling agent dimension can be at most 100% the third energy device dimension. In some cases, the third coupling agent dimension can be about 0.01%, about 0.05%, about 0.1%, about 0.5%, about 1.0%, about 5.0%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the third energy device dimension. In some cases, the third coupling agent dimension can be from about 0.0001% to about 0.1%, from about 0.0005% to about 0.5%, from about 0.001% to about 1%, from about 0.005% to about 2%, from about 0.01% to about 5%, from about 0.05% to about 10%, or from about 1% to about 100% of the third energy device dimension.

The acoustic module can be designed to conform to a surface of the energy device and also to fit within a compartment of, for example, an energy producing or energy storage compartment. The device can comprise a compact form factor that makes it highly portable (e.g., easy to be carried around in a user's bag or purse). Exemplary dimensions (e.g., length, width and height) of the device can be given as follows. In some embodiments, the length (l_{A}) or width (w_{A}) of the acoustic module ranges from about 10 μm to about 10 inches. l_{A} Or w_{A} can be from about 50 μm to about 5 inches, from about 100 μm to about 2 inches, or from about 200 μm to about 1 inch. In some embodiments, l_{A} or w_{A} is about 10 mm, about 25 mm, about 50 mm, about 75 mm, about 100 mm, about 200 mm, about 500 mm, about 750 mm, about 1000 mm, about 1250 mm, or about 1500 mm. In some cases, l_{A} Or w_{A} is at least about 10 μm, about 20 μm, about 50 μm, about 100 μm, or about 500 μm. In some cases, l_{A} or w_{A} is at most about 0.5 inch, about 1 inch, about 2 inches, about 5 inches, or about 10 inches. Individual acoustic devices of the above dimensions can be used in parallel or in series to result in larger total dimensions (e.g., total length, total width, total height).

The height of the acoustic device (h_{A}) can vary. The height of the acoustic device ranges from about 10 μm to about 5 mm. The height of the acoustic device can range from about 10 μm to about 5,000 μm. The height of the acoustic device can range from about 10 μm to about 50 μm, about 10 μm to about 100 μm, about 10 μm to about 250 μm, about 10 μm to about 500 μm, about 10 μm to about 750 μm, about 10 μm to about 100 μm, about 10 μm to about 2,000 μm, about 10 μm to about 5,000 μm, about 50 μm to about 100 μm, about 50 μm to about 250 μm, about 50 μm to about 500 μm, about 50 μm to about 750 μm, about 50 μm to about 100 μm, about 50 μm to about 2,000 μm, about 50 μm to about 5,000 μm, about 100 μm to about 250 μm, about 100 μm to about 500 μm, about 100 μm to about 750 μm, about 100 μm to about 100 μm, about 100 μm to about 2,000 μm, about 100 μm to about 5,000 μm, about 250 μm to about 500 μm, about 250 μm to about 750 μm, about 250 μm to about 100 μm, about 250 μm to about 2,000 μm, about 250 μm to about 5,000 μm, about 500 μm to about 750 μm, about 500 μm to about 100 μm, about 500 μm to about 2,000 μm, about 500 μm to about 5,000 μm, about 750 μm to about 100 μm, about 750 μm to about 2,000 μm, about 750 μm to about 5,000 μm, about 100 μm to about 2,000 μm, about 100 μm to about 5,000 μm, or about 2,000 μm to about 5,000 μm. The height of the acoustic device can be about 10 μm, about 50 μm, about 100 μm, about 250 μm, about 500 μm, about 750 μm, about 100 μm, about 2,000 μm, or about 5,000 μm. The height of the acoustic device can be at least about 10 μm, at least about 50 μm, at least about 100 μm, at least about 250 μm, at least about 500 μm, at least about 750 μm, at least about 100 μm, or at least about 2,000 μm. The height of the acoustic device can be at most about 50 μm, at most about 100 μm, at most about 250 μm, at most about 500 μm, at most about 750 μm, at most about 100 μm, at most about 2,000 μm, or at most about 5,000 μm. These dimensions can be applied to any of the xy-plane, yz-plane, or xz-plane.

The acoustic device can be positioned along a surface of the energy device. For example, the acoustic device may be disposed over or adjacent to the energy device, forming an interface between the acoustic device and the energy device. In some embodiments, the housing of the acoustic device interfaces with an external surface of the energy device at the interface. The housing can be configured to be attached to the external surface of the energy device such that the housing covers an entire plane extending across the external surface. In some cases, the housing can be configured to be attached to a portion of the external surface of the energy device. In some cases, the portion can be located near or at an edge of the external surface of the energy device.

As discussed previously, the energy devices described herein comprise at least two electrodes and an electrode gap interspaced between the two electrodes. The two electrodes can comprise a cathode and an anode. The electrode gap may comprise an electrolyte. The electrode gap can optionally have a separator. The energy device can comprise a tab, e.g., a battery tab. In some instances, the energy device can comprise a plurality of tabs, e.g., battery tabs.

The acoustic device may be positioned relative to the energy device to direct acoustic devices to a specific region within the energy device. For example, as illustrated generally in FIGS. 3A-14C, the acoustic device can be positioned near a center of a surface of the energy device. The surface can correspond to an external surface of the energy device. The surface can comprise a regular or irregular shape, as discussed below.

In some embodiments, the portion is located near or at a center of the external surface of the energy device. The portion can be offset from a center of the external surface of the energy device.

In some aspects, the acoustic device may be placed relative to the energy device, such that the acoustic device overlaps (e.g., overlaps about 10%, about 20%, about 30%, about 40%, about 50%, about 60%, about 70%, about 80%, about 90%, or about 100%) with the energy device. For example, an area of the housing of the acoustic device may overlap with about 10%, about 20%, about 30%, about 40%, about 50%, about 60%, about 70%, about 80%, about 90%, or about 100% of a portion of the external surface of the energy device. The housing can be configured to be attached to the portion of the external surface of the energy device. In some instances, the housing of the acoustic device is oriented to overlap with about 10%, about 20%, about 30%, about 40%, about 50%, about 60%, about 70%, about 80%, about 90%, or about 100% of a surface of the electrode, such as a cathode of an anode of the energy device, or a surface of the electrode gap. If multiple acoustic devices are used, each of the acoustic devices can independently overlap with about 10%, about 20%, about 30%, about 40%, about 50%, about 60%, about 70%, about 80%, about 90%, or about 100% of a surface of the electrode or a surface of the electrode gap.

The housing of the acoustic device can be positioned or located near an edge of the external surface of the energy device. In some cases, the housing can be located at the edge of the external surface of the energy device. In some instances, the portion (corresponding to the overlap) can be located near an edge of the external surface of the energy device. The portion can be located at an edge of the external surface. In some cases, the portion can be near or at a center of the external surface of the external surface. Alternatively, the portion can be off-set or off-center relative to a center of the external surface, which is described in greater detail below.

### IV. Multiple Acoustic Devices

An acoustic module can comprise multiple acoustic devices. The multiple acoustic devices can have housings that are configured to be attached to the external surface of the energy device.

Each of the multiple acoustic devices can be programmed or configured to generate the same type of acoustic wave or acoustic waves with substantially the same frequency and/or power. The multiple acoustic devices can be configured to generate different acoustic waves. The multiple acoustic devices may be in communication with each other. Alternatively, the multiple acoustic devices may operate independently of each other.

In some embodiments, the plurality of acoustic devices can be configured to be attached to the external surface such that the plurality of acoustic devices lies on a same plane extending across the external surface.

The external surface of the energy device can comprise at least two external surfaces that lie on different planes, and wherein the plurality of acoustic devices can be configured to be attached to the at least two external surfaces.

The at least two external surfaces can be orthogonal to one another. In some instances, the at least two external surfaces can be parallel to one another. In some instances, the at least two external surfaces can be opposite to one another. In some instances, the at least two external surfaces can be adjacent to one another. In some instances, the different planes can be located on at least two different axes.

In some instances, the plurality of acoustic devices comprises two to about five hundred acoustic devices. In some cases, the plurality of acoustic devices comprises more than five hundred acoustic devices.

The multiple acoustic devices may be adjacent to each other such that the acoustic devices lie on the same plane of a battery. For example, if an energy device is equipped with two acoustic devices, the acoustic devices can be placed on the same plane or face (e.g., FIG. 13A) or on different planes or faces (e.g., FIGS. 13B and 13C) via the housing. The flexibility of the configurations illustrates the added technical benefit of utilizing a housing because the acoustic devices can be placed in any number of configurations without disrupting the energy device manufacturing process.

### V. Coupling Agent

The acoustic device as described herein can optionally interact with a coupling agent that can be configured to attach the acoustic device to the external surface of the energy device. The coupling agent can fix or immobilize the acoustic device to the energy device, thus providing a fixed source of acoustic waves. The coupling agent can fix the acoustic device to the energy device, while enabling propagation of generated acoustic waves from the acoustic wave generator. Alternatively, the coupling agent can be a physical fixture, such as a paste or epoxy. In some instances, the coupling agent can comprise a paste, a mechanical fixture, or a coupling fluid. In some instances, both a mechanical fixture and a physical fixture can be used to secure the acoustic device adjacent to the energy device. The coupling agent can provide a strong bond between the acoustic device and the energy device such that the acoustic device remains in a fixed position when the energy device is in use.

The coupling agent can fill the gap between the energy device and the acoustic device. In some embodiments, the coupling agent is configured to completely (e.g., about 100%) fill a gap between a surface of the at least one acoustic device and the external surface of the energy device. In some embodiments, the coupling agent is configured to partially (e.g., about 10%, about 20%, about 30%, about 40%, about 50%, about 60%, about 70%, about 80%, or about 90%) fill a gap between a surface of the at least one acoustic device and the external surface of the energy device. For example, the coupling agent can fill about 0.1% to about 100% of a width of the gap (w_{G}). Specifically, the coupling agent can fill about 5%, about 10%, about 15%, about 20%, about 25%, about 30%, about 35%, about 40%, about 45%, about 50%, about 55%, about 60%, about 65%, about 70%, about 75%, about 80%, about 85%, about 90% or about 95% of the width of the gap. In some instances, the coupling agent can extend beyond the gap and the external surface of the energy device. The coupling agent can completely cover an entire plane (e.g., 100% of the external surface) extending across the external surface of the energy device. Alternatively, the coupling agent can partially cover the external surface of the energy device, such as about 10%, about 20%, about 30%, about 40%, about 50%, about 60%, about 70%, about 80%, or about 90% of the external surface. If multiple acoustic devices and coupling agents are used, then the total area of the external surface covered by the coupling agent can be about 10%, about 20%, about 30%, about 40%, about 50%, about 60%, about 70%, about 80%, or about 90% of the external surface.

With reference to FIGS. 3A-16D, a coupling agent 125 may fill a gap between the acoustic device 105 and the energy device 102. The coupling agent may be disposed over the portion of the external surface of the energy device. For instance, as illustrated in FIGS. 2A-2C, 3A-3C, 7, and 8A-8C, the coupling agent can cover a plane extending across the external surface of the energy device. For example, the coupling agent can cover about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the external surface of the energy device.

The coupling agent can comprise a dimension relative to the corresponding dimension of the acoustic device. For example, the coupling agent may have a first coupling agent dimension (e.g., length (l_{C})) that can be about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the corresponding first acoustic device dimension (e.g., length (l_{A})). In some cases, the coupling agent may have a length (l_{C}) that is greater than 100% of l_{A}. In some instances, the coupling agent can have a second coupling agent dimension (e.g., width (w_{C})) that can be about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the corresponding second dimension of the acoustic device (e.g., width (w_{A})). In other instances, the coupling agent can have a third dimension (e.g., height (h_{C})) that can be about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of a corresponding third dimension of the acoustic device (e.g., height (h_{A})).

The coupling agent can be positioned relative to the acoustic device. For instance, the acoustic device may comprise a dimension, e.g., a length, width, or height, that is relative to a dimension, e.g., length, width, or height, of the energy device. When the dimension of the acoustic device is less than the corresponding dimension of the energy device (e.g., l_{A} is less than l_{E}), then the acoustic device may be positioned relative to an edge of the energy device. For instance, as illustrated in FIGS. 3A, 3C, 4A, 4C, 5A, 5C, 6A, 8B, 8C, 9B, and 9C, an edge of the acoustic device is aligned to an edge of the energy device. For example, in FIG. 8B, a top edge of the acoustic device can be aligned to a top edge of the energy device. In some cases, a coupling agent is used, as in FIG. 8B, and a top edge of the coupling agent can be further aligned to a top edge of the energy device. Alternatively, in some embodiments, a bottom edge of the acoustic device can be aligned to a bottom edge of the energy device. As in FIG. 8C, a bottom edge of the coupling agent can be aligned to a bottom edge of the energy device.

For example, the coupling agent may be positioned along a center of a face of the acoustic device, as illustrated in FIGS. 8A, 9A, 10A-10C, and 13A-16D. The terms “center” or “off-center” or “offset” describe a position relative to a center axis of a face, as illustrated in FIG. 2A, wherein the center axis is equidistant from opposing edges of the face. In some instances, the coupling agent may be centered over a face of the acoustic device. In some embodiments, when l_{A} and l_{C} are substantially the same, the coupling agent and the acoustic device may be centered relative to each other, as illustrated in FIGS. 4A-4C, 5A-5C, 9A-9C, 10A-10C, and 13A-16D. In some instances, l_{A} can be greater than l_{C}, such that the acoustic device extends over about 100% of a surface and beyond the coupling agent, as illustrated in FIGS. 6A-6C and 11A-11C. In some cases, the acoustic device and the coupling are each off-center of the energy device and off-center relative to each other, as illustrated in FIGS. 6A-6C and 11A-11C. For example, the acoustic device may be off-center relative to a center axis of the coupling agent. Optionally, a side of the acoustic device can be aligned to a side of the coupling agent. In some instances, the side of the acoustic side can be aligned to a side of the energy device but not aligned to the side of the coupling agent, as illustrated in FIGS. 6A, 6C, 11B, and 11C. In some cases, with reference to a center axis of the energy device, the coupling agent may be about 10%, about 20%, about 30%, about 40%, or about 50% away from the center axis. Separately, the acoustic device can be about 10%, about 20%, about 30%, about 40%, or about 50% away from the center axis. In some cases, the coupling agent and the acoustic device can each be a different distance away from the center axis of the energy device. The coupling agent and the acoustic device can be a same distance away from the center axis of the energy device, as illustrated in FIGS. 4A-4C, 5A-5C, 8A, and 9A.

With reference to FIGS. 3A-3C, the coupling agent 125 can comprise a width (w_{C}) substantially similar to the width of the acoustic device 105 (w_{A}), such that the direction of the acoustic waves can be parallel to the direction of cation flow in the energy device 102. The coupling agent 125 and the acoustic device 105 can comprise a width (w_{C}) greater than the corresponding width of the acoustic device (w_{A}). The coupling agent can substantially overlap with (e.g., about 90% or about 100%) with the external surface of the energy device. The acoustic device can overlap with a portion of the coupling agent (such as about 10%, about 20%, about 30%, about 40%, about 50%, about 60%, about 70%, or about 80%). The width of the acoustic device (w_{A}) can be less than the width of the coupling agent (w_{C}) and the energy device (w_{E}).

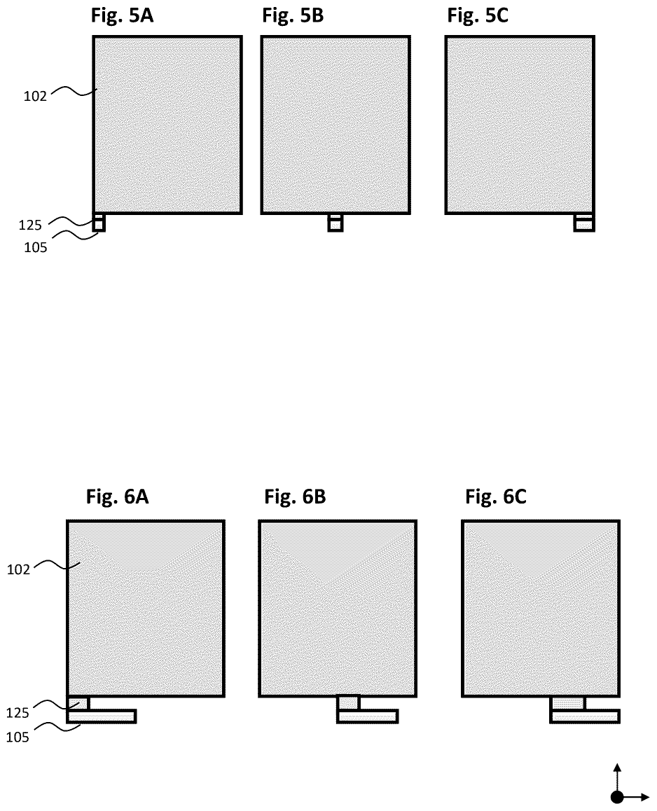

In some instances, at least one dimension of each of the acoustic device, the coupling agent, and the energy device are different. For example, l_{A}, l_{C}, and l_{E} are each different. As illustrated in FIGS. 4A-6C, at least one dimension (e.g., a length) of the energy device can be greater than the corresponding dimension of the coupling agent or the acoustic device. In some cases, as illustrated in FIGS. 4A-4C, l_{E} is greater than l_{C} and l_{A} individually. The sum of l_{C} and l_{A} can be about equal to l_{E}. In some cases, the sum of l_{C} and l_{A} can be greater than l_{E}. Alternatively, the sum of l_{C} and l_{A} can be less than l_{E}, as illustrated in FIGS. 5A-5C. In some cases, l_{C} is less than l_{A}, which is less than l_{E}, as illustrated in FIGS. 6A-6C.

When w_{C} and w_{A} are substantially the same, the surface of the acoustic device 105 can substantially overlap with the region of the coupling agent 125, which substantially overlaps with the portion of the external surface of the energy device 102, as illustrated in FIGS. 4A-4C. In some instances, the acoustic device 105 comprises a width (w_{A}) about equal to the width of the coupling agent (w_{C}), and the acoustic device 105 may be disposed adjacent to the edge of the external surface of the energy device 102, as illustrated in FIGS. 4A, 4C, 5A, and 5C. In some embodiments, the acoustic module may be disposed adjacent to a center of the external surface of the energy device, as illustrated in FIGS. 4B and 5B.

With reference to FIGS. 6A-6C, the acoustic device 105 can comprise a w_{A} greater than a w_{C} of the coupling agent 125. In some configurations, w_{A} may be (e.g., substantially) greater than w_{C} such that a surface of the acoustic device 105 covers 100% of the coupling agent 125 and extends beyond a plurality of edges of the coupling agent 125, as illustrated in FIGS. 6A-6C. When a dimension of the acoustic agent (e.g., w_{A}, l_{A}, h_{A}) is greater than the corresponding dimension of the coupling agent (e.g., w_{C}, l_{C}, h_{C}), then the acoustic device 105 can be positioned relative to a center axis or plane of the coupling agent 125. For instance, a center of the acoustic device 105 may align with the center of the coupling agent 125. The center of the acoustic device 105 may be off-center with respect to the center of the coupling agent (e.g., about 10%, about 20%, about 30%, about 40%, about 50%, about 60%, about 70%, about 80%, about 90% or about 100%). In some instances, the center of the acoustic device 105 may be positioned off-center with respect to the center of the coupling agent such that a side of the coupling agent is aligned with a side of the acoustic device, as illustrated in FIGS. 6A, 6B, and 6C. If the side of the coupling agent and the side of the acoustic device are aligned, the acoustic device and the coupling agent may be positioned away from the center of the energy device 102 (e.g., e.g., about 10%, about 20%, about 30%, about 40%, about 50%, about 60%, about 70%, about 80%, about 90% or about 100%, wherein 100% away corresponds to a position adjacent to an edge of the energy device 102 as shown in FIG. 6A). Each of the coupling agent 125 and the energy device 105 may be independently positioned away from the center of the energy device 102. For example, the coupling agent 125 may be about 50% away from the center axis of the energy device 102, whereas the acoustic device 105 may be about 90% away from the center axis of the energy device 102.

The coupling agent can be a material or a mechanism that secures the acoustic device or acoustic module to the energy device. The generated acoustic waves can propagate through the coupling agent, wherein the coupling agent does not decrease the amplitude of the generated acoustic waves. Alternatively, the coupling agent decreases the amplitude of the generated acoustic waves by about 5%, about 10%, about 15%, about 20%, or about 25% the initial amplitude of the acoustic wave. The coupling agent can minimally interfere with the acoustic wave. For example, the coupling agent does not shift a phase of the acoustic wave. Additionally, the coupling agent can be a paste, or a coupling fluid. The coupling agent can be an adhesive. For example, the coupling agent may be epoxy. In some instances, the coupling agent can be a mechanical fixture, e.g., snapfit, screws, and the like.

### VI. Mounting Surface

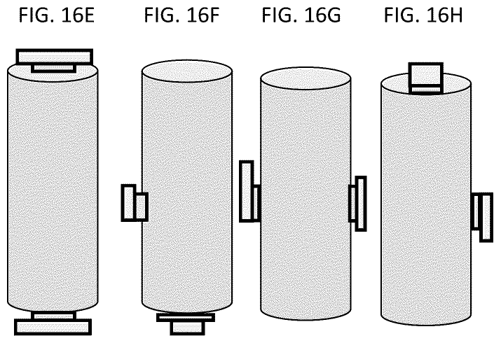

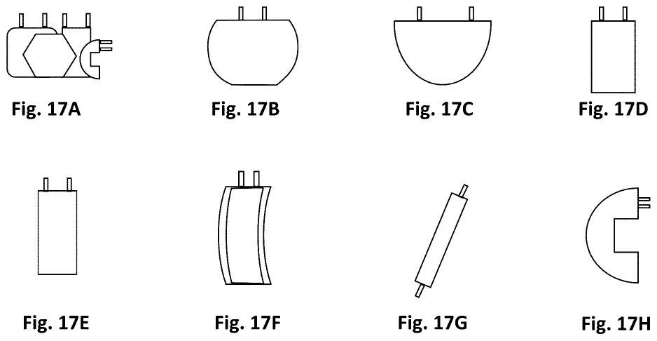

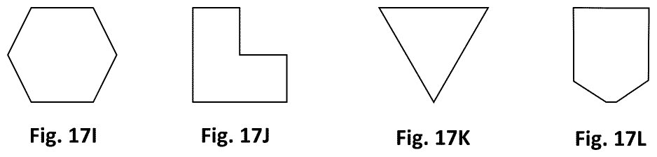

An advantage of the acoustic device as described herein is the flexibility and adaptability with which the acoustic device can be installed or implemented adjacent to a myriad of energy devices. For instance, the acoustic device may be mounted onto or adjacent to an external surface of the energy device. The external surface can be a planar surface or a non-planar surface. The external surface of the energy device may be a planar surface. The external surface can be a non-planar surface (e.g., a curved surface or irregular surface), such as in curved batteries or irregularly shaped batteries as illustrated in FIGS. 16A-16H and 17A-17L.

In some embodiments, the external surface comprises a non-planar surface of the energy device. In some embodiments, the external surface comprises a cylindrical surface of the energy device, such as the energy device illustrated in FIGS. 16A-16H.

In some embodiments, the SAW module may be integrated with an energy device (e.g., cell), for example in the locations shown in FIGS. 7 and 9A.

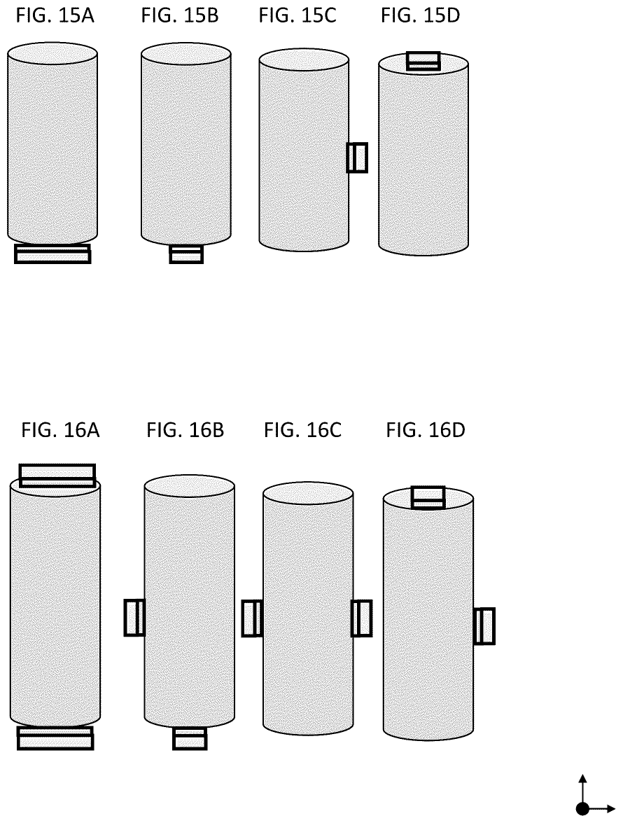

In some embodiments, the SAW module may be integrated with an energy device (e.g., cell), for example in the locations shown in FIG. 15B.

The housing of the acoustic device can be ergonomically designed to form a seal with the planar or non-planar surface of the energy device.

In some embodiments, the housing is configured to conform to the external surface of the energy device. In some embodiments, the coupling agent is configured to conform to the external surface of the energy device, thus enabling the housing to conform to the external surface of the energy device. For example, the energy device can comprise a cylindrical shape and a radius of curvature. The housing of the acoustic device, e.g., the base of the housing, can comprise a corresponding radius of curvature that conforms to the cylindrical shape of the energy device.

Any external surface of the energy device can be operably coupled to the acoustic device. For example, in a rectangular-shaped battery, any one of the six surfaces, as shown in FIGS. 2A and 2B, can be operably coupled to the acoustic device. For a rectangular battery, the six surfaces can each and independently be a planar surface. In some cases, the planar surface can correspond to a largest planar surface of the energy device. The acoustic module can interface with or be in communication with the largest planar surface of the energy device. In some cases, the acoustic module can interface with a face that is not the largest planar surface.

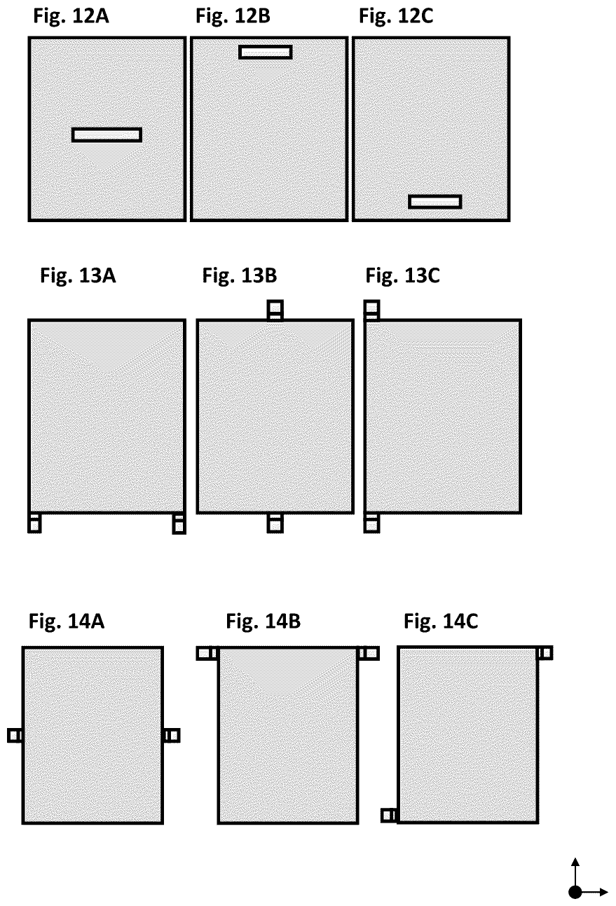

With reference to FIGS. 13A-14C and 16A-16H, in some embodiments, a plurality (e.g., a pair) of acoustic modules are operably coupled to the energy device. The plurality of acoustic devices may be oriented opposite to each other, adjacent to each other, or a combination thereof. For example, a pair of acoustic modules may be operably coupled to a first side and a second side. In some cases, the first side and the second side are the same. In some cases, the first side and the second side are different. In some cases, the pair of acoustic modules may be coaxial. In some cases, the pair of acoustic modules may be orthogonal. As illustrated in FIGS. 12A-12C, a top-down view illustrates that the acoustic module may be centered or off centered relative to an axis (e.g., y-axis) or a plane (e.g., xz or yz plane) along the device. In some embodiments, as in FIGS. 12B and 12C, the acoustic module may be off center relative to the axis or the plane. The axis or the plane can be down a center of a face of the energy device, such as the front face, the top, or the first side. For example, the axis can divide the front face when the axis runs along xz plane or x-axis, thus the distance from the center plane or axis to each of the first side and the second side is ½ w_{A}. The acoustic module can be positioned about 0%, about 10%, about 20%, about 30%, about 40%, about 50%, about 60%, about 70%, about 80%, or about 90% away from the center axis or plane. The degree to which the acoustic device may be positioned away from a center (i.e., off-center or offset) from the axis or plane can be defined as ½ of the dimension. For example, the acoustic device can be positioned at a distance of 70% of ½ l_{A}. If l_{A} comprises a length of about 80 mm, then the acoustic device is positioned at about 70% of 40 mm (or ½ l_{A}), or 28 mm away from the center axis or plane. In some cases, when the acoustic module is about 0% away from the center axis or plane, the acoustic device is centered with respect to the energy device along a dimension of the energy device. In some cases, when the acoustic module is about 100% away from the center axis or plane, the acoustic module may be adjacent to an edge of the energy device, as illustrated in FIGS. 3A, 3C, 4A, 4C, 5A, 5C, 8B, 8C, 9B, 9C, 10B, 10C, 11B, 11C, 13A, 13C, 14B, and 14C. For example, in FIGS. 3A-6C, the acoustic module can be aligned relative to a yz plane that runs across the energy device or a y-axis. In some cases, as in FIGS. 7-12C, the acoustic module may be aligned relative to a xz plane or x-axis of the energy device.

A plurality of acoustic devices can modulate the formation of cationic deposits, such as Li dendrites. An advantage of using multiple acoustic devices is through providing multiple sources of acoustic waves. Furthermore, integration of multiple acoustic devices can be useful for larger energy devices or energy systems. As exemplified in FIGS. 13A-13C, 14A-14C, and 16A-16H, a pair of acoustic modules may be operably coupled to the energy device.

The acoustic modules, by way of the housings of the acoustic devices of the acoustic modules, can be attached to the external surface of the energy device. The housings of the acoustic devices can be configured to attach to at least two external surfaces of the energy device. The at least two external surfaces can lie on a same plane extend across the external surface, as generally illustrated in FIG. 13A. The at least two external surfaces can lie on different planes, as generally illustrated in FIGS. 13B, 13C, and 14A-14C. The at least two external surfaces can be any of the top (e.g., the top 130), bottom (e.g., the bottom 135), the first side (e.g., the first side 140), the second side (e.g., the second side 145), the front face (e.g., the front face 150), or the back face (e.g., back face 155). The at least two surfaces can be orthogonal, parallel, opposite, or adjacent to one another.

The acoustic modules can be placed such that the generated waves propagate in a direction parallel to each other. In FIG. 13A, the pair of acoustic modules can be in operable communication on a same side (e.g., a bottom side, a top side, a first side, and/or a second side) of the energy device. In some cases, the pair of acoustic modules may be oriented to stream acoustic waves in the same direction. For example, a pair of acoustic modules may be oriented to stream acoustic waves in an opposite direction, as illustrated in FIGS. 13B, 13C, and 14A-14C. In some cases, a pair of acoustic modules may be oriented to stream acoustic waves in orthogonal directions. As illustrated in FIGS. 13B, 13C, 14A-14C, 16A, and 16C, a pair of acoustic modules may be operably coupled to an energy device such that each of the acoustic modules are opposite each other. The pair of acoustic modules can be oriented antiparallel to each other along an axis (e.g., the y-axis, the x-axis, or the z-axis). In some cases, the acoustic modules may be opposite and off center relative to each other. In some cases, the acoustic modules may be opposite each other and adjacent to an edge of the energy device.

In some aspects, the configuration of the acoustic device permits acoustic waves to be streamed in a plurality of directions, as illustrated in FIGS. 13A-13C, 14A-14C, and 16A-16H, through a number and variety of cells. When multiple acoustic devices are used, each acoustic device may be aligned relative to an axis or a plane. For example, if a pair of acoustic devices is used and positioned orthogonal to each other, the first acoustic device can be positioned on the bottom of the acoustic device, as illustrated in FIGS. 16B and 16D. The second acoustic device can be positioned over a side of the energy device. The first acoustic device can be positioned relative to an xz plane or an x-axis. The second device can be positioned relative to a yz plane or a y-axis.

The configuration of the acoustic module can permit streaming the acoustic waves in a direction that is substantially orthogonal to an electrode gap of the energy device. Alternatively, the configuration permits the acoustic waves to be streamed in a direction that is non-orthogonal to an electrode gap of the energy device. Alternatively, the configuration of the acoustic module permits the acoustic waves to be streamed in a direction that is substantially parallel to an electrode gap of the energy device. Alternatively, the configuration permits the acoustic waves to be streamed in a direction that is non-parallel to an electrode gap of the energy device. In some instances, the configuration provides an acoustic streaming direction that is independent of a position of one or more tabs of the energy device. Alternatively, the configuration provides an acoustic streaming direction that is dependent on a position of one or more tabs of the energy device. The one or more tabs may be one or more battery tabs.

In some instances, a plurality (e.g., a pair) of acoustic modules may be disposed over at least two external surfaces of the energy device. The at least two surfaces can be a first side and a second side of the energy device, such that the acoustic modules are configured to stream acoustic waves orthogonal to an electrode gap of the energy devices, as generally illustrated in FIGS. 14A-14C. The first side can be different from the second side. Alternatively, the first side can be opposed to the second side, as shown in FIGS. 14A-14C. In some cases, each of the plurality of acoustic modules are oriented adjacent to a center of the first face and the second face, respectively, as illustrated in FIG. 14A. In some cases, the first edge and the second edge are adjacent to a top side, such as in FIG. 14B. The plurality of acoustic modules can be oriented at a first edge and a second edge, wherein each of the first edge and second edge are adjacent to a top side of the energy device, such as in FIG. 14B. In some embodiments, one of the plurality of acoustic modules is disposed adjacent to a first edge of a first side (e.g., a bottom side or a top side), and the remaining acoustic modules of the plurality of acoustic modules is disposed adjacent to a second edge of a second side (e.g., a top side or a bottom side), such as in FIG. 14C. In some cases, one of the plurality of acoustic modules is configured adjacent to a first edge (e.g., a top edge or a bottom edge) of a first side. In some cases, the remaining acoustic module of the plurality of acoustic modules is configured adjacent to a second edge (e.g., a top edge or a bottom edge) of a second side, such as in FIG. 14C.

The energy devices can comprise an external surface. The external surface can be a non-planar surface. The non-planar surface can correspond to, for example, a curved surface, an angled surface, or an irregularly-shaped surface, as illustrated in FIGS. 17A-17L. For example, the external surface can be a cylindrical surface, as illustrated in FIG. 15A-15C, 16A-16C, 17B, 17C, 17F, 17G, or 17H. The acoustic module or device can conform to the irregularly shaped surface by way of the housing. The base can be designed to conform to the irregularly shaped surface. When present, the coupling agent can conform to the irregularly shaped surface, such that the base of the housing can attach (e.g., via physical mechanisms) to the energy device. In some instances, the acoustic module can be disposed over a top or a bottom side of the energy device, such that the acoustic module extends over a smallest plane (e.g., about 90% or about 100% over the plane) of the external surface, as illustrated in FIG. 15A. In some instances, the acoustic module or acoustic device extends over a portion of the smallest plane (e.g., about 10%, about 20%, about 30%, about 40%, about 50%, about 60%, about 70%, or about 80% of the smallest plane). The smallest plane can correspond to a top or a bottom of the energy device, as illustrated in FIG. 15A, 15B, or 15D. In some instances, the acoustic module or device can be mounted adjacent to a largest surface. The acoustic module or device can be disposed over a portion (e.g., 10%, about 20%, about 30%, about 40%, about 50%, about 60%, about 70%, about 80%, or about 90%) of the external surface, as illustrated in FIG. 15C.

When multiple acoustic devices (e.g., a plurality of devices) are implemented, the acoustic devices may be disposed adjacent to different parts of the energy device, as generally illustrated in FIGS. 16A-D. For example, one of the multiple acoustic devices can be disposed over, e.g., 100%, of a smallest surface (e.g., a top or a bottom) of the energy device. Another of the multiple acoustic devices can be disposed over, e.g., 100%, of another smallest surface or other surface of the energy device. In some instances, the multiple acoustic devices may be disposed adjacent to surfaces that are opposite each other, as illustrated in FIGS. 16A and 16C. In some instances, the multiple acoustic devices may be positioned to be orthogonal to each other, as illustrated in FIGS. 16B and 16D.

In contrast to other devices, when multiple acoustic devices according to the disclosure are used, the acoustic devices can be oriented orthogonal to each other without being integrated into the energy device itself, thus provided a technical advantage of providing orthogonal sources of acoustic waves. Additionally, another technical advantage provided by the modular aspect of using the acoustic devices is the added option of providing antiparallel or orthogonal placement of acoustic wave generators.

### VII. Energy Systems

The acoustic devices of the present disclosure can be operably coupled to energy devices. The energy device can be provided in a form of one or more electrochemical or battery cells. The energy device can be provided in a form of one or more electrochemical or battery modules. The energy device is provided in a form of one or more electrochemical or battery packs.

The acoustic devices can be integrated into individual energy devices, such as battery cells, electrochemical cells, fuel cells, and the like, and the individual energy devices can, in turn, be integrated into energy systems. The format of the battery cells can be cylindrical, pouch, prismatic or irregular types. In some cases, the acoustic devices can also be integrated into energy systems, such as batteries, which comprise a plurality of cells. For example, the acoustic device can be mounted onto a battery such that it provides acoustic waves to the plurality of battery cells within the battery. In some instances, the individual cells can be grouped together to form a pouch (e.g., a cell pouch or prismatic pouch), wherein the individual cells may be individually equipped an acoustic device. The cells within the pouches can be any battery cell, electrochemical cell, fuel cell (e.g., a solid oxide fuel cell (SOFC), molten carbonate fuel cell (MCFC), or the like), capacitor, supercapacitor, and the like. In some embodiments, the energy device can be any type of battery including, for example, a lithium (Li) battery, a sodium (Na) battery, a potassium (K) battery, a copper (Cu) battery, a zinc (Zn) battery, a magnesium (Mg) battery, or a lithium ion battery.

In some instances, commercially available batteries may be assembled with the acoustic devices and modules described herein. For example, multiple commercially available batteries may be grouped together, and an acoustic module can be assembled adjacent to the grouped batteries. The grouped batteries can be a battery module. Alternatively, individual batteries with acoustic devices or acoustic modules as described herein can be grouped together to form a modified battery module.

Battery packs can be used in concert with the acoustic modules and acoustic devices as described herein. For instance, the battery packs can comprise battery modules having acoustic modules. Alternatively, an acoustic module or an acoustic device may be mounted or used in combination with the battery pack. For example, the housing of the acoustic device can be mounted adjacent to a battery pack. In some instances, a plurality of acoustic devices within the acoustic module can be grouped together, such that a separate housing over the acoustic module can be mounted adjacent to the battery pack.

As illustrated by the examples above, an advantage of the acoustic modules and devices herein is the flexibility and ease with which a user can integrate an acoustic module or device onto a ready-made or commercially available battery. By contrast, manufacturing a battery with an acoustic module or acoustic device integrated within the battery can be costly to manufacture and require significant time to design.

In some instances, the battery can comprise the acoustic devices integrated as a part of an acoustic module that is, in turn, mounted adjacent to a battery module. In some instances, the acoustic modules can be assembled to form a single source of acoustic waves, and the single source of acoustic waves can be mounted adjacent to a battery module. The battery module (or multiple battery modules) having the acoustic modules can be assembled or integrated into a battery pack. In some instances, the acoustic modules can be assembled to form a large acoustic module, which is in turn integrated or mounted adjacent to a battery pack.

The acoustic modules and acoustic devices can be configured to interface with a number of shapes of the energy device. For instance, the energy device can comprise a regular shape. In some instances, the energy device can comprise an irregular shape or a customed shape. The energy device can comprise one or more pouch cells, prismatic cells, or cylindrical cells. The irregular shape can be a polygonal shaped battery (e.g., FIG. 17L), which can include triangular shaped batteries (e.g., FIG. 17K), rectangular batteries (e.g., FIG. 17D, 17E), pentagonal batteries, hexagonal batteries (e.g., FIG. 17I), and the like. Irregularly-shaped batteries can include L-shaped batteries (e.g., FIG. 17J), curved batteries (e.g., FIG. 17F), round lipo batteries (e.g., FIG. 17C), or C-shaped batteries (e.g., FIG. 17H). Other irregularly-shaped batteries can include ultranarrow batteries (e.g., FIG. 17G), ultrathin batteries (e.g., FIG. 17E), D-shaped batteries (e.g., FIG. 17B), and the like.

The energy device system can comprise an energy device, which comprises at least one cathode and at least one anode. In some instances, the cathode comprises a cation. The cation can be Li ion. The cathode can be made of a 3-D material, such as a ceramic, a perovskite, a ceramic/polymer composite, or the like. The 3-D material can comprise at least two conductive elements. The conductive elements can be any element from Group 1 through Group 16 of the Periodic Table of Elements. In some instances, the conductive elements can be any element from Group 1 through Group 12 of the Periodic Table of Elements. The anion of the electrode can be any element from Group 16 or 17 of the Periodic Table of Elements. The anion can be a material selected from the group consisting of: oxides, fluorides, oxyfluorides, sulfur-based materials, and gases. In some instances, the cathode can be selected from the group consisting of: LiFePO₄; LiMn₂O₄; LiNi_{0.5}Mn_{1.5}O₄; LiNiₓCo_{y}Mn₂O₂, wherein x+y+z=1; LiCoO₂; LiNiₓCo_{y}Al₂O₂, wherein x+y+z=1; LiFeₓMn_{y}PO₄, wherein x+y=1; and ₐLiNiₓCo_{y}MnzO₂·(1−a)Li₂MnO₃, wherein a=0-1 and x+y+z=1. In some instances, the cathode of the energy device can be Lithium free. In some embodiments, the cathode can be lithium containing intercalation chemistry-based or intercalation type-layered (e.g., involving transition metal oxides, transition metal phosphate, vanadium oxides, molybdenum oxides) for Li ion battery or Li metal battery. In some embodiments, the cathode can be sodium containing intercalation chemistry-based or intercalation type-layered (e.g., involving transition metal oxides, transition metal phosphate, iron hexacyanoferrate (prussian blue, prussian white), vanadium oxides, molybdenum oxides) for Na ion battery or Na metal battery. In some embodiments, the cathode can be potassium containing intercalation chemistry-based or intercalation type-layered (e.g., involving transition metal oxides, transition metal phosphate, iron hexacyanoferrate (prussian blue, prussian white), vanadium oxides, molybdenum oxides) for K ion battery or K metal battery.

In some embodiments, the cathode can comprise a layered lithium intercalated transition metal oxides, lithium intercalated transition metal oxides, lithium intercalated phosphate, pre-lithiated sulfur, pre-lithiated multivalent metal fluorides, pre-lithiated multivalent metal sulfides, or pre-lithiated multivalent metal oxides. In some embodiments, the cathode can comprise a layered sodium intercalated transition metal oxide, sodium intercalated transition metal oxide, sodium intercalated phosphate, sodium intercalated iron hexacyanoferrate (prussian blue, prussian white), pre-sodiated sulfur, pre-sodiated multivalent metal fluorides, pre-sodiated multivalent metal sulfides, or pre-sodiated multivalent metal oxides. In some embodiments, the cathode can comprise a layered potassium intercalated transition metal oxide, potassium intercalated transition metal oxide, potassium intercalated phosphate, potassium intercalated iron hexacyanoferrate (prussian blue, prussian white), pre-potassiated sulfur, pre-potassiated multivalent metal fluorides, pre-potassiated multivalent metal sulfides, or pre-potassiated multivalent metal oxides.

In some instances, the anode can be made of an anode material capable of catalyzing a chemical reaction. In some embodiments, the anode can comprise an anode material, such as graphite, graphene, Al, Cu, Si, Sn, SiOₓ, SnOₓ, P, lithium titanium oxide (LTO), hard carbon, or soft carbon, or a combination thereof.

The anode of the energy device can be made of an anode material that can provide a current. The anode material can be a material intercalated with a cation. The cation can be lithium ion. The anode material can also be a Li metal foil, Li metal on Cu foil, Li metal on carbon substrate, Li metal on porous metal substrate, or Li metal on porous carbon substrate, etc.

In some instances, the anode can be made of an anode material capable of catalyzing a chemical reaction. The anode material can be a perovskite, a ceramic, a cermet, or the like. The perovskite can comprise the chemical formula ABX3, wherein A and B are each independently a metal, and X can be an element from Group 16 or 17 of the Periodic Table of Elements. The metal of A and B can be any metal from Groups 1 to 12 of the Periodic Table of Elements. In some cases, the anode comprises an anode material, such as graphite, graphene, Al, Cu, Si, Sn, SiOₓ, SnOₓ, P, lithium titanium oxide (LTO), hard carbon, or soft carbon, or a combination thereof.

In some embodiments, the energy device can comprise an electrolyte. The electrolyte can be made of a material that enables cation transport between the electrodes of the energy device. When the energy device is coupled with the acoustic device of the present disclosure, the electrolyte can be perturbed by the generated acoustic waves. The electrolyte material can be a solid, a gel, or a combination thereof. In some instances, the electrolyte can be a nonaqueous electrolyte, aqueous electrolyte, semi-solid electrolyte, liquified gas electrolyte, or polymer gel electrolyte. The electrolyte material can be a porous material, such that cations or charge carriers can diffuse through the electrolyte. For example, the electrolyte material can be a porous material with an average pore diameter suitable for Li ion diffusion. In some instances, the electrolyte salt can be LiPF₆. In some cases, the electrolyte material can be an aqueous electrolyte, such as an ionic liquid. The ionic liquid can be a quaternary amine, such as imidazolium, NH₄⁺, pyrrolidinium, or piperidinium. In some instances, a nonaqueous electrolyte may be present. In some cases, the nonaqueous electrolyte may comprise a carbonate, an ether, a phosphate, a sulfone, an ionic liquid, an amide, a ketone, an ester, an alcohol, an aromatic, or the like. In some instances, the carbonate may comprise ethylene carbonate (EC), propylene carbonate (PC), dimethyl carbonate (DMC), or the like. In some cases, the ether may comprise diethyl ether (DEE), tetrahydrofuran (THF), dioxolane (DIOX), or the like. In some instances, the phosphate may comprise trimethyl phosphate (TMP), triethyl phosphate (TEP), or the like. In some cases, the sulfone may comprise sulfolane, 1,3-propane sulfone, or the like. In some cases, the ionic liquid may comprise an imidazolium-based salt, pyridinium-based salt, or the like. In some instances, the amide may comprise N,N-dimethylformamide (DMF), N-methylacetamide (NMA), or the like. In some instances, the ketone may be acetone, 2,3-butanedione. In some instances, the ester may be ethyl acetate, butyl acetate, and the like. In some cases, the alcohol may be methanol, ethanol, propanol, isopropanol, butanol, and the like. In some instances, the nonaqueous electrolyte may comprise an aromatic solvent, such as toluene, xylene, and the like.

In some embodiments, the energy system can comprise a controller configured to: determine, based at least on a feedback signal, a morphology of an interior of an energy cell of the energy device; and control, based at least on the morphology, an operation of the energy cell. In some embodiments, the controller may be configured to terminate the operation of the energy cell in response to the feedback signal indicating an adverse morphology including, for example, the presence of dendrites and/or air bubbles on the surface of the electrodes. In some embodiments, the controller may terminate the operation of the energy device by at least electrically decoupling the energy cell from an electric load of the energy device and/or another energy cell in a same energy system, upon detecting the presence of adverse morphology. In some embodiments, the energy system can be coupled with an additional controller (e.g., controller 106 as shown in FIG. 1C) configured to determine, based at least on a feedback signal, a morphology of an interior of the energy device; and control, based at least on the morphology, an operation of the acoustic device. In some embodiments, the controller can modulate the operation of the acoustic device, i.e., frequency, power, and/or on/off pulsing.

### VIII. Computer Systems

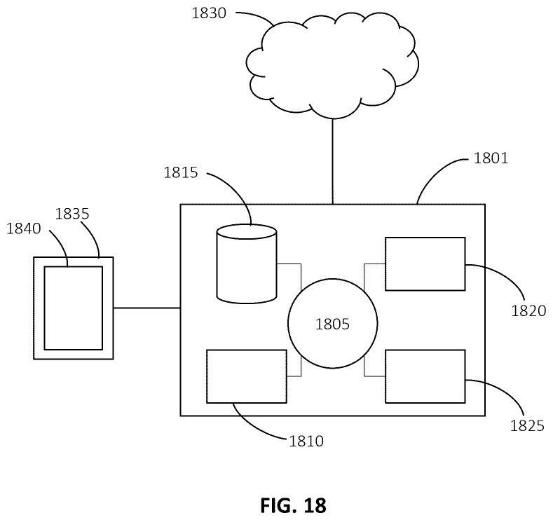

The present disclosure provides computer systems that are programmed to implement methods of the disclosure. FIG. 18 shows a computer system 1801 that is programmed or otherwise configured to receive an output from a device, system or apparatus according to the embodiments disclosed herein. For example, the computer system 1801 may be configured to receive output from an acoustic device or an energy system as described herein. The computer system 1801 can regulate various aspects of generating acoustic waves of the present disclosure, such as, for example, frequency, wavelength, amplitude or power, types of waveforms. The computer system 1801 can be an electronic device of a user or a computer system that is remotely located with respect to the acoustic device or acoustic module according to the disclosure. The electronic device can be a mobile electronic device.

The computer system 1801 includes a central processing unit (CPU, also “processor” and “computer processor” herein) 1805, which can be a single core or multi core processor, or a plurality of processors for parallel processing. The computer system 1801 also includes memory or memory location 1810 (e.g., random-access memory, read-only memory, flash memory), electronic storage unit 1815 (e.g., hard disk), communication interface 1820 (e.g., network adapter) for communicating with one or more other systems, and peripheral devices 1825, such as cache, other memory, data storage and/or electronic display adapters. The memory 1810, storage unit 1815, interface 1820 and peripheral devices 1825 are in communication with the CPU 1805 through a communication bus (solid lines), such as a motherboard. The storage unit 1815 can be a data storage unit (or data repository) for storing data. The computer system 1801 can be operatively coupled to a computer network (“network”) 1830 with the aid of the communication interface 1820. The network 1830 can be the Internet, an internet and/or extranet, or an intranet and/or extranet that is in communication with the Internet. The network 1830 in some cases is a telecommunication and/or data network. The network 1830 can include one or more computer servers, which can enable distributed computing, such as cloud computing. The network 1830, in some cases with the aid of the computer system 1801, can implement a peer-to-peer network, which may enable devices coupled to the computer system 1801 to behave as a client or a server.

The CPU 1805 can execute a sequence of machine-readable instructions, which can be embodied in a program or software. The instructions may be stored in a memory location, such as the memory 1810. The instructions can be directed to the CPU 1805, which can subsequently program or otherwise configure the CPU 1805 to implement methods of the present disclosure. Examples of operations performed by the CPU 1805 can include fetch, decode, execute, and writeback.

The CPU 1805 can be part of a circuit, such as an integrated circuit. One or more other components of the system 1801 can be included in the circuit. In some cases, the circuit is an application specific integrated circuit (ASIC).

The storage unit 1815 can store files, such as drivers, libraries and saved programs. The storage unit 1815 can store user data, e.g., user preferences and user programs. The computer system 1801 in some cases can include one or more additional data storage units that are external to the computer system 1801, such as located on a remote server that is in communication with the computer system 1801 through an intranet or the Internet.

The computer system 1801 can communicate with one or more remote computer systems through the network 1830. For instance, the computer system 1801 can communicate with a remote computer system of a user (e.g., personal health device, laptop, monitoring device, or any other device commonly used by a health practitioner). Examples of remote computer systems include personal computers (e.g., portable PC), slate or tablet PC's (e.g., Apple® iPad, Samsung Galaxy Tab), telephones, Smart phones (e.g., Apple® iPhone, Android-enabled device, Blackberry®), or personal digital assistants. The user can access the computer system 1801 via the network 1830.

Methods as described herein can be implemented by way of machine (e.g., computer processor) executable code stored on an electronic storage location of the computer system 1801, such as, for example, on the memory 1810 or electronic storage unit 1815. The machine executable or machine readable code can be provided in the form of software. During use, the code can be executed by the processor 1805. In some cases, the code can be retrieved from the storage unit 1815 and stored on the memory 1810 for ready access by the processor 1805. In some situations, the electronic storage unit 1815 can be precluded, and machine-executable instructions are stored on memory 1810.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 1801, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1801 can include or be in communication with an electronic display 1835 that comprises a user interface (UI) 1840 for providing. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1805.

### IX. Methods

Provided herein are methods of assembling an energy system using the energy device and acoustic devices herein. For instance, an energy system can be assembled by providing an acoustic device and coupling the acoustic device to an energy device. As described above, the acoustic device can comprise an acoustic wave generator within a housing. The energy device can be any energy device as described herein. The acoustic device can be operably coupled to the energy device via the housing of the acoustic device to an exterior of the energy device.

The method can involve using a controller to control the acoustic wave generator. The acoustic wave generator can generate waves for streaming into the energy device to improve energy device performance for the one or more products.

The method can also involve incorporating the energy system into a greater system. For example, the energy system can be incorporated into an electric vehicle, a personal electronic device, or the like.

In some aspects, methods of reducing charging time, enhancing charge cycles, increasing energy storage, increasing an energy device lifetime, and decreasing safety risks are provided herein. The acoustic module and the acoustic device(s) may increase charge cycles by about 2×, about 3×, about 4×, about 5×, about 6×, about 7×, about 8×, about 9×, or about 10× standard energy devices in the market (e.g., commercially available batteries) or energy devices without the acoustic module or acoustic device. The acoustic module and the acoustic device(s) may increase an energy storage of the energy device by about 2×, about 3×, about 4×, about 5×, about 6×, about 7×, about 8×, about 9×, or about 10× standard energy devices in the market or energy devices without the acoustic module or acoustic device. The acoustic module and the acoustic device(s) may an energy device lifetime by about 2×, about 3×, about 4×, about 5×, about 6×, about 7×, about 8×, about 9×, or about 10× standard energy devices in the market or energy devices without the acoustic module or acoustic device. The acoustic modules and acoustic devices may decrease the risk of hazards associated with battery use, such as shorting and combustion of device components upon exposure to air and/or moisture.

As used in the specification and claims, the singular form “a”, “an” and “the” include plural references unless the context clearly dictates otherwise. For example, the term “a cell” includes a plurality of cells, including mixtures thereof.

As used herein, the term “about” a number refers and to that number plus or minus 10%, 9%, 8%, 7%, 6%, 5%, 4%, 3%, 2%, 1%, of that number.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. For example, depending on the particular parameter, property, or condition that is substantially met, the parameter, property, or condition may be at least 90.0% met, at least 95.0% met, at least 99.0% met, or at least 99.9% met.

### EXAMPLES

Example 1: An acoustic wave device that can trigger microscale or nanoscale acoustofluidics when coupled with a fluid. The acoustic device is made of a piezoelectric substrate and generates surface acoustic waves (SAWs). The wave is confined within four wavelength (λ_{AW}) from the surface of the piezoelectric materials. The wave is selected from leaky SAW, love wave, Bleustein Gulyaev wave, surface skimming bulk wave, and surface transverse waves.

Example 2: An acoustic wave device that can affect the microscale or nanoscale fluids when the acoustic wave is actuated with fluids surrounded. The wave can be a bulk wave, for example, thickness mode, thickness shear mode, longitudinal bulk wave, or any combination thereof. Those wave types can be used to integrate with an energy device and effectively affect the energy device performances.

Example 3: An acoustic wave device that shown in the Example 1 or Example 2 with frequency from 10 Hz to 500 MHz, power from 0.1 mW to 50 W, which can generate effective acoustic wave to an energy device system. The wave type can be continuous sine wave, square wave, triangular wave, pulse wave with different 0-100% ON/OFF time and with different time scale (e.g., total period is 50 μs). The wave can effectively improve the energy device performance.

Example 4: An acoustic is integrated with an energy device, either directly attached to an energy device or attached from an energy device pack. The number of acoustic devices is varied (e.g., scaled) with the individual cell geometry and overall energy device pack design. At least one acoustic device is mounted onto one pack. The mounted solution can be, but not limited to, a paste, a mechanical fixture, or a coupling fluid.

Example 5: Example of the acoustic device mounted to a pouch/prismatic cell where the acoustic streaming direction is parallel (i.e., vertical, or along the y-axis) to the electrode gap regardless to the position of the battery tabs (FIGS. 3A-6C). The x, y, z are the length (l_{E}), width (w_{E}), and the height (h_{E}) of a cell, while the x′, y′, and z′ are the width (w_{A}), length (l_{A}), and the thickness (h_{A}) of an acoustic device. The w_{E} can be larger than (or smaller or equal) to l_{E} and h_{E}. Similarly, the w_{A} can be larger than (or smaller than, or equal to) l_{A} and h_{A}. The position of the acoustic device to an energy device can be varied.

Example 6: Similar approach to example 5, but the acoustic device is mounted to a pouch/prismatic cell where the acoustic streaming direction is orthogonal (i.e., horizontal, or along an x-axis) to the electrode gap regardless to the position of the battery tabs FIGS. 14A-14C.

Example 7: The acoustic device can be mounted on to the largest, flat surface of a pouch/prismatic cell, as illustrated in FIGS. 12A-12C.

Example 8: Multiple acoustic devices can be integrated onto one cell (FIGS. 13A-14C). The SAW devices on one cell can range from 1 SAW device to 500 SAW devices on one energy device. The energy device can be a battery.

Example 9: The acoustic device can be integrated with cylindrical cells. The possible designs are illustrated in FIGS. 15A-15D and 16A-16D.

Example 10: Multiple acoustic devices of varying dimensions are integrated with cylindrical cells, as illustrated in FIGS. 16E-16H.

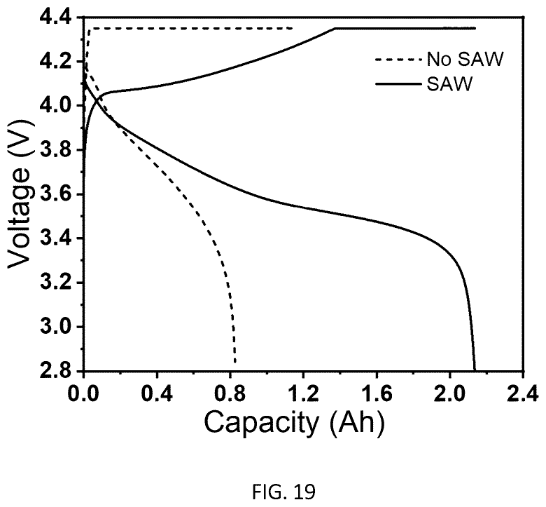

Example 11: A pouch cell with a graphite anode and LiNi_{0.5}Mn_{0.3}Co_{0.2}O₂ cathode were tested with and without SAW module integration to the cells. The SAW module was integrated along a side of the cell by way of a coupling agent. The SAW module was placed along a center of the bottom face of the pouch cell such that the generated SAWs would run perpendicular to the direction of Li ion flow, as illustrated in FIGS. 7 and 9A. The SAW module facilitated Li ion transport inside the battery. As a result, under fast charging (>2C) condition, the cell with SAW showed a lower overpotential (FIG. 19). FIG. 19 illustrates a graph of voltage in volts (V) on the y-axis as a function of capacity in amp-hours (Ah) on the x-axis of devices with or without the acoustic devices during charging and discharging. The charge capacity of the SAW-integrated cells (“SAW” of FIG. 19) during constant current stage was measured as 1.38 Ah, while the cell without SAW (“No SAW” of FIG. 19) showed nearly 0 capacity, even after constant voltage charge step at 4.35V with C/20 cut-off, followed by C/3 discharge rate. The discharge capacity of the cell without SAW delivered only 0.82 Ah capacity. The SAW cell presented 160% improvement with a discharge capacity of 2.13 Ah.

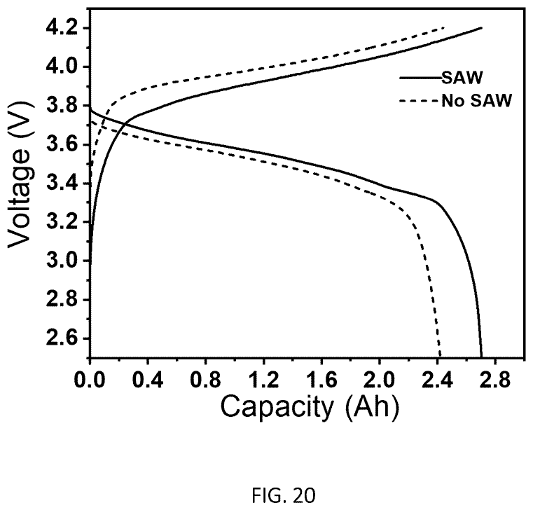

Example 12: A cylindrical cell with a graphite anode and an NMC cathode were tested with and without SAW module integration to the cells. The SAW module was integrated along a side of the cell by way of a coupling agent. The SAW module was placed along a center of the bottom face of the cylindrical cell, such as in FIG. 15B. FIG. 20 illustrates a graph of voltage in volts (V) on the y-axis as a function of capacity in amp-hours (Ah) on the x-axis of devices with or without the acoustic devices during charging and discharging. The SAW module facilitated Li ion transport inside the battery, and, as a result, under fast charging (>2C) condition, the cell with SAW (“SAW” of FIG. 20) showed a lower overpotential. The discharge capacity of the cell without SAW (“No SAW” of FIG. 20) delivered 2.4 Ah capacity. The SAW cell (“SAW” of FIG. 20) presented a 12.5% improvement with a discharge capacity of 2.7 Ah.

While preferred embodiments have been shown and described herein, it will be obvious to those skilled in the art that such embodiments are provided by way of example only. It is not intended that the disclosure be limited by the specific examples provided within the specification. Numerous variations, changes, and substitutions will now occur to those skilled in the art without departing from the disclosure. Furthermore, it shall be understood that aspects of the disclosure are not limited to the specific depictions, configurations or relative proportions set forth herein which depend upon a variety of conditions and variables. It should be understood that various alternatives to the embodiments described herein may be employed in practice. It is therefore contemplated that the disclosure shall also cover any such alternatives, modifications, variations or equivalents. It is intended that the following claims define the scope of the disclosure and that methods and structures within the scope of these claims and their equivalents be covered thereby.

1. An acoustic module for improving energy device performance, the acoustic module comprising:
at least one acoustic device configured to be operably coupled to an energy device, wherein the at least one acoustic device comprises:
(1) an acoustic wave generator configured to generate acoustic waves and
(2) a housing enclosing the acoustic wave generator,
wherein the housing is configured to be attached to an external surface of the energy device in a configuration that permits the acoustic waves to be streamed into the energy device; and
at least one controller configured to control the at least one acoustic device to stream the acoustic waves into the energy device.

2. The acoustic module of claim 1, wherein the at least one acoustic device is provided in a quantity based at least on a cell geometry and/or pack design of the energy device, for optimizing improvements in the energy device performance.

3. The acoustic module of claim 1, wherein the configuration permits the acoustic waves to be streamed in a direction that is substantially orthogonal to an electrode gap of the energy device.

4. The acoustic module of claim 1, wherein the configuration permits the acoustic waves to be streamed in a direction that is non-orthogonal to an electrode gap of the energy device.

5. The acoustic module of claim 1, wherein the configuration permits the acoustic waves to be streamed in a direction that is substantially parallel to an electrode gap of the energy device.

6. The acoustic module of claim 1, wherein the configuration permits the acoustic waves to be streamed in a direction that is non-parallel to an electrode gap of the energy device.

7. The acoustic module of claim 1, wherein the configuration provides an acoustic streaming direction that is independent of a position of one or more tabs of the energy device.

8. The acoustic module of claim 1, wherein the configuration provides an acoustic streaming direction that is dependent on a position of one or more tabs of the energy device.

9. The acoustic module of claim 1, wherein the at least one acoustic device has a same dimension as the energy device along at least one axis.

10. The acoustic module of claim 1, wherein the at least one acoustic device has a different dimension from the energy device along at least one axis.

11. The acoustic module of claim 1, wherein the at least one acoustic device has a same width as the energy device.

12. The acoustic module of claim 1, wherein the at least one acoustic device has a same length as the energy device.

13. The acoustic module of claim 1, wherein the at least one acoustic device has a same height as the energy device.

14. The acoustic module of claim 1, wherein the at least one acoustic device has a smaller width than the energy device.

15. The acoustic module of claim 14, wherein a width of the at least one acoustic device ranges from about 0.0001% to about 100% of a width of the energy device.

16. The acoustic module of claim 1, wherein a height of the at least one acoustic device ranges from about 10 μm to about 5 mm.

17. The acoustic module of claim 1, wherein a length or a width of the at least one acoustic device ranges from 10 μm to about 10 inches.

18. The acoustic module of claim 1, wherein the housing is configured to be attached to the external surface of the energy device such that the housing covers an entire plane extending across the external surface.

19. The acoustic module of claim 1, wherein the housing is configured to be attached to a portion of the external surface of the energy device.

20. The acoustic module of claim 19, wherein the portion is located near or at an edge of the external surface of the energy device.
